(19) United States
(12) Patent Application Publication
(10) Pub. No.: US 2026/0238386 A1
(43) Pub. Date: Aug. 13, 2026

(54) COMMUNICATION APPARATUS, CONTROL METHOD, AND STORAGE MEDIM

(71) Applicant: CANON KABUSHIKI KAISHA, Tokyo (JP)

(72) Inventor: IBUKI YOSHIDA, Tokyo (JP)

(21) Appl. No.: 19/531,141

(22) Filed: Feb. 5, 2026

(30) Foreign Application Priority Data
Feb. 7, 2025 (JP) 2025-019591

(51) Int. Cl. H04L 1/08; H04L 1/16

(52) U.S. Cl. CPC H04L 1/08; H04L 1/16

(57) ABSTRACT

A communication apparatus includes a processor, and a memory storing a program which, when executed by the processor, causes the communication apparatus to: perform processing for acquiring data from a first apparatus; perform processing for storing, in a storage unit, the data acquired from the first apparatus; perform processing for transferring the data stored in the storage unit to a second apparatus different from the first apparatus; and perform processing for, in a case where transfer of the data to the second apparatus failed, if the data the transfer of which failed is divided data constituting a data group, not deleting the divided data from the storage unit and, if the data the transfer of which failed is not divided data constituting the data group, deleting the data the transfer of which failed from the storge unit.

### BACKGROUND

### Field of the Technology

The present disclosure relates to a communication apparatus, a control method, and a storage medium.

### Description of the Related Art

There is a technique which causes an image capturing apparatus such as a digital video camera to be equipped with a wireless communication function and generates a file obtained by recording a moving image which is input from the image capturing apparatus while dividing the moving image in every short time (hereinafter, the file being referred to as a "chunk recording file"). Moreover, a technique in which an image capturing apparatus sequentially performs transmission starting with a chunk recording file the generation of which has been completed to an external apparatus (such as that described in Japanese Patent Laid-Open No. 2003-134435) is known. Using such a function enables more efficiently transmitting a moving image to an external apparatus.

In recent years, in image capturing locations for the mass media industry such as news organizations or telecommunication companies, there is a need to promptly deliver content obtained by image capturing on the ground to news organization, and each company is providing a file transfer solution using a network communication.

In one example, a transfer application is provided which transmits and stores an image, a moving image, or an audio file captured or recorded by a camera to and in a mobile or portable terminal such as a smartphone. Additionally, the transfer application transmits such stored content from the mobile or portable terminal to an external File Transfer Protocol (FTP) server via a network.

Moreover, such a mobile application has a function of automatically performing a series of processing operations. The series of processing operations includes, upon receiving a recording completion notification for a moving image file from an image capturing apparatus via, for example, Picture Transfer Protocol / Internet Protocol (PTP/IP), acquiring a moving image file from the image capturing apparatus. Then, the series of processing operations includes transferring the acquired moving image file to an external FTP server (hereinafter, the function being referred to as an "image capturing automatic transfer function"). Accordingly, by enabling the image capturing automatic transfer function, without performing an operation for selecting a file obtained by image capturing, the user can cause the file to be automatically delivered to a delivery destination.

Generally, moving image files obtained by chunk recording (hereinafter referred to as "chunk moving image files") are united at the delivery destination and are thus treated as one moving image. Therefore, at the time of delivery, it is necessary that a serial file group, from a beginning chunk moving image file to an ending chunk moving image file, is complete.

In response to the above-mentioned image capturing automatic transfer function being enabled, the above-mentioned mobile application transitions to a state of being able to receive a recording completion notification for chunk moving image files from the image capturing apparatus. After that, upon receiving the recording completion notification for chunk moving image files from the image capturing apparatus, the mobile application acquires chunk moving image files from the image capturing apparatus and then transfers the chunk moving image files to an external FTP server. However, in a case where the mobile application has failed in transmitting some chunk moving image files out of a serial file group, from a beginning chunk moving image file to an ending chunk moving image file, the mobile application is required to re-acquire chunk moving image files from the image capturing apparatus and transmit the re-acquired chunk moving image files to the FTP server. As a result, there is an issue that requires a lot of time and effort.

### SUMMARY

According to an aspect of the present disclosure, a communication apparatus includes a processor, and a memory storing a program which, when executed by the processor, causes the communication apparatus to: perform processing for acquiring data from a first apparatus; perform processing for storing, in a storage unit, the data acquired from the first apparatus; perform processing for transferring the data stored in the storage unit to a second apparatus different from the first apparatus; and perform processing for, in a case where transfer of the data to the second apparatus failed, if the data the transfer of which failed is divided data constituting a data group, not deleting the divided data from the storage unit and, if the data the transfer of which failed is not divided data constituting the data group, deleting the data the transfer of which failed from the storge unit.

Features of the present disclosure will become apparent from the following description of embodiments with reference to the attached drawings. The following description of embodiments is described by way of example.

### BRIEF DESCRIPTION OF THE DRAWINGS

FIG. 1 is a conceptual diagram illustrating a system configuration in a first embodiment.

FIGS. 2A and 2B are a block diagram illustrating a configuration of an image capturing apparatus in the first embodiment and a perspective view illustrating an example of an appearance of the image capturing apparatus, respectively.

FIG. 3 is a block diagram illustrating a configuration of a communication apparatus in the first embodiment.

FIGS. 4A and 4B are diagrams used to explain features of chunk recording in the first embodiment.

FIGS. 5A, 5B, 5C, and 5D are diagrams each illustrating a screen user interface (UI) of a transfer application which the communication apparatus in the first embodiment controls.

FIGS. 6A, 6B, and 6C are diagrams illustrating a transfer processing sequence for chunk recording files which is executed between the image capturing apparatus, the communication apparatus, and a server in the first embodiment.

FIG. 7 is a flowchart illustrating processing which the communication apparatus performs concerning transmission of chunk moving image files which the communication apparatus performs in the first embodiment.

FIG. 8 is a flowchart illustrating processing which the communication apparatus performs concerning determination of deletion of a moving image file which the communication apparatus performs in the first embodiment.

FIG. 9 is a diagram illustrating a list of failed chunk moving image file information about a communication apparatus in a second embodiment.

FIGS. 10A, 10B, and 10C are diagrams illustrating a transfer processing sequence for chunk recording files which is executed between an image capturing apparatus, the communication apparatus, and a server in the second embodiment.

FIG. 11 is a flowchart illustrating processing which the communication apparatus performs concerning updating of failed chunk moving image file information about the communication apparatus in the second embodiment.

FIG. 12 is a flowchart illustrating processing which the communication apparatus performs concerning determination of deletion of a moving image file which the communication apparatus performs in the second embodiment.

FIG. 13 is a diagram illustrating an updating processing sequence for failed chunk moving image file information obtained after connection establishment which is performed between the image capturing apparatus and the communication apparatus in the second embodiment.

FIG. 14 is a flowchart illustrating processing which the communication apparatus performs concerning updating of failed chunk moving image file information obtained after connection establishment which is performed between the image capturing apparatus and the communication apparatus in the second embodiment.

FIG. 15 is a diagram illustrating a list of failed chunk moving image file information about a communication apparatus in a third embodiment.

FIG. 16 is a diagram illustrating a retransmission processing sequence for a chunk moving image file the transmission of which between the communication apparatus and a server failed in the third embodiment.

FIG. 17 is a flowchart illustrating processing which the communication apparatus performs concerning retransmission of a chunk moving image file the transmission of which failed in the third embodiment.

### DESCRIPTION OF THE EMBODIMENTS

Various embodiments, features, and aspects of the present disclosure will be described in detail below with reference to the drawings.

Furthermore, embodiments which are described below are merely examples of implementation aspects of the present disclosure, and can be modified or altered depending on configurations of apparatuses to which the present disclosure is applied and various conditions. Moreover, some or all of the embodiments can be combined as appropriate.

### First Embodiment

### Configuration of System

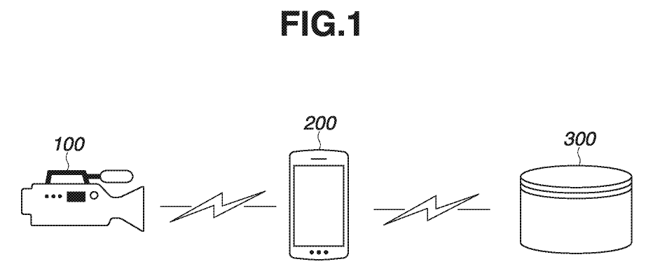

FIG. 1 is a schematic diagram used to explain a system configuration in a first embodiment of the present disclosure.

Referring to FIG. 1, the system configuration includes an image capturing apparatus 100 such as a digital video camera (an example of a first apparatus). The system configuration further includes a communication apparatus 200 serving as a mobile terminal, which is an information processing apparatus equipped with a communication function, such as that typified by a smartphone or computer. The system configuration further includes a server 300 (an example of a second apparatus), which is an image storage apparatus installed at a connection destination connected via a communication network such as the Internet.

Referring to FIG. 1, the image capturing apparatus 100 and the communication apparatus 200 are connected to each other by wired communication or wireless communication via a connection method such as a wired cable or Wi-Fi, and thus enable a moving image file or audio file generated by the image capturing apparatus 100 to be transferred to the communication apparatus 200. The communication apparatus 200 and the server 300 are connected to each other via a connection method such as a mobile data communication, and thus enable information stored in the communication apparatus 200 to be transferred to the server 300 by a communication using, for example, the File Transfer Protocol (FTP).

Furthermore, the system configuration is not limited to the above-mentioned one, and, for example, without the use of a mobile data communication, the image capturing apparatus 100, the communication apparatus 200, and the server 300 can be connected to the same network via access points, thus implementing transfer processing of files between the respective apparatuses.

### Configuration of Image Capturing Apparatus 100

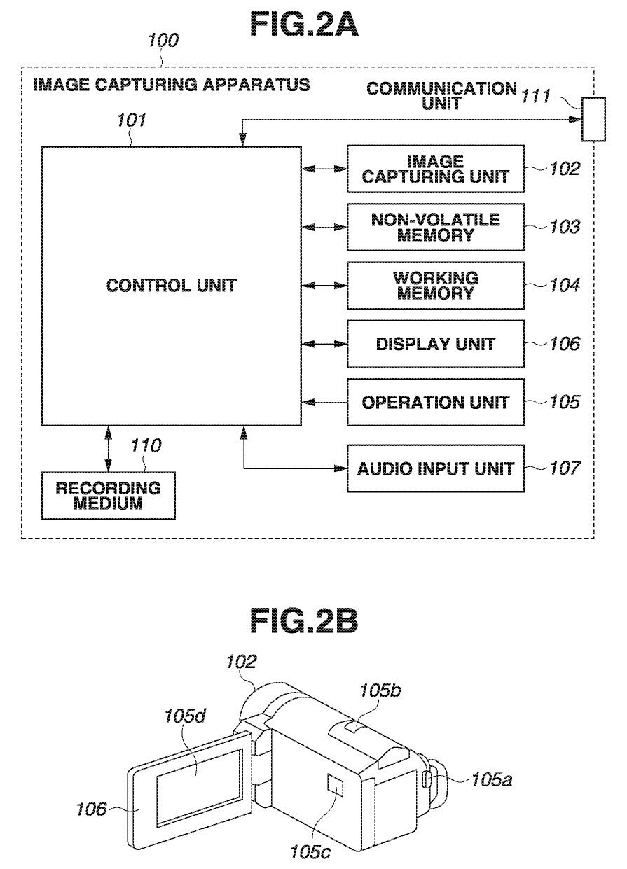

FIG. 2A is a block diagram illustrating a hardware configuration example of the image capturing apparatus 100 in the first embodiment. Furthermore, while, here, a digital camera is described as an example of an image capturing apparatus, the image capturing apparatus is not limited to this. For example, the image capturing apparatus can be a portable-type media player or an information processing apparatus such as a tablet device or personal computer.

A control unit 101 controls each unit of the image capturing apparatus 100 according to an input signal or a program described below. Furthermore, instead of the control unit 101 controlling the entire image capturing apparatus 100, a plurality of pieces of hardware can share processing to control the entire image capturing apparatus 100.

An image capturing unit 102 is configured with, for example, an optical system which controls, for example, an optical lens unit, a diaphragm, zooming, and focusing, and an image sensor which converts light (e.g., video image) introduced via the optical lens unit into an electrical video signal. The image sensor to be used can be, generally, a complementary metal-oxide semiconductor (CMOS) sensor or a charge-coupled device (CCD) sensor. Under the control of the control unit 101, the image capturing unit 102 converts subject light imaged by a lens included in the image capturing unit 102 into an electrical signal with use of the image sensor, performs, for example, noise reduction processing on the electrical signal to obtain digital data, and outputs the digital data as moving image data. Regarding the image capturing apparatus 100 in the first embodiment, the moving image data is then recorded on a recording medium 110.

A non-volatile memory 103 is an electrically erasable and recordable non-volatile memory, in which, for example, a program described below which is executed by the control unit 101 and meta-template information are stored.

A working memory 104 is used as, for example, a buffer memory which temporarily retains moving image data captured by the image capturing unit 102, a moving image displaying memory for a display unit 106, and a working area for the control unit 101.

An operation unit 105 is used to receive, from the user, an instruction which the user issues to the image capturing apparatus 100. The operation unit 105 includes, for example, a power button via which the user issues an instruction for powering-on and powering-off of the image capturing apparatus 100, a release switch via which the user issues an instruction for starting and stopping of image capturing, and a playback button via which the user issues an instruction for reproduction of moving image data. Additionally, the operation unit 105 includes an operation member such as a dedicated connection button via which the user issues an instruction for starting of a communication with external equipment via a communication unit 111 described below. Moreover, a touch panel formed on the display unit 106 described below is also included in the operation unit 105.

The display unit 106 performs, for example, displaying of a viewfinder image at the time of image capturing, displaying of captured moving image data, and displaying of characters for an interactive operation. Furthermore, the image capturing apparatus 100 does not necessarily need to have the display unit 106 incorporated therein. The image capturing apparatus 100 may connect to the internal or external display unit 106 and may include at least a display control function which controls a displaying operation of the display unit 106.

An audio input unit 107 is a device configured to input audio information, and audio data obtained by being converted from audio information by the audio input unit 107 is then recorded in an audio file format on the recording medium 110.

The recording medium 110 is capable of recording thereon moving image data output from the image capturing unit 102 and audio data output from the audio input unit 107. The recording medium 110 can be configured to be attachable to and detachable from the image capturing apparatus 100 or can be incorporated in the image capturing apparatus 100. Thus, the image capturing apparatus 100 may have a method for accessing at least the recording medium 110.

The communication unit 111 is an interface used to connect to an external apparatus. The image capturing apparatus 100 in the first embodiment is able to exchange data with an external apparatus via the communication unit 111. For example, the image capturing apparatus 100 is able to transmit moving image data generated by the image capturing unit 102 and audio data generated by the audio input unit 107 to an external apparatus via the communication unit 111. Furthermore, in the first embodiment, the communication unit 111 includes an interface for communicating with an external apparatus by what is called a wireless local area network (LAN) conforming to the standard of IEEE 802.11. Moreover, the communication unit 111 also includes a Universal Serial Bus (USB) interface for communicating with an external apparatus by a USB cable. The control unit 101 implements wired communication and wireless communication by controlling the communication unit 111.

Furthermore, the communication unit 111 included in the image capturing apparatus 100 in the first embodiment includes an access point mode (hereinafter referred to as "AP mode") for operating as an access point in the infrastructure mode. Additionally, the communication unit 111 includes a client mode (hereinafter referred to as "CL mode") for operating as a client in the infrastructure mode. Then, by causing the communication unit 111 to operate with the CL mode, the image capturing apparatus 100 in the first embodiment is able to operate as CL equipment in the infrastructure mode. In the case of operating as CL equipment, by connecting to near AP equipment, the image capturing apparatus 100 is able to participate in a network which the AP equipment forms. Moreover, by causing the communication unit 111 to operate with the AP mode, the image capturing apparatus 100 in the first embodiment is also able to operate as a simplified AP (hereinafter referred to as a "simple AP") which is one of types of APs but is more limited in function.

When the image capturing apparatus 100 operates as a simple AP, the image capturing apparatus 100 forms a network by itself. An apparatus located near the image capturing apparatus 100 recognizes that the image capturing apparatus 100 is AP equipment and thus becomes able to participate in a network which the image capturing apparatus 100 has formed. It is assumed that, as mentioned above, a program for causing the image capturing apparatus 100 to operate is retained in the non-volatile memory 103.

Furthermore, the image capturing apparatus 100 in the first embodiment is one of types of APs but is a simple AP which does not have a gateway function which transfers data received from CL equipment to, for example, an Internet provider. Accordingly, even when receiving data from another apparatus which is participating in a network which the image capturing apparatus 100 has formed, the image capturing apparatus 100 is not able to transfer the received data to a network such as the Internet.

Next, an external appearance of the image capturing apparatus 100 is described. FIG. 2B is a diagram illustrating an example of the external appearance of the image capturing apparatus 100. A release switch 105a, a zoom lever 105b, a playback button 105c, and a touch panel 105d are operation members which are included in the above-mentioned operation unit 105. Moreover, a moving image obtained as a result of image capturing performed by the image capturing unit 102 is displayed on the display unit 106.

Thus far is the description of the image capturing apparatus 100.

### Configuration of Communication Apparatus 200

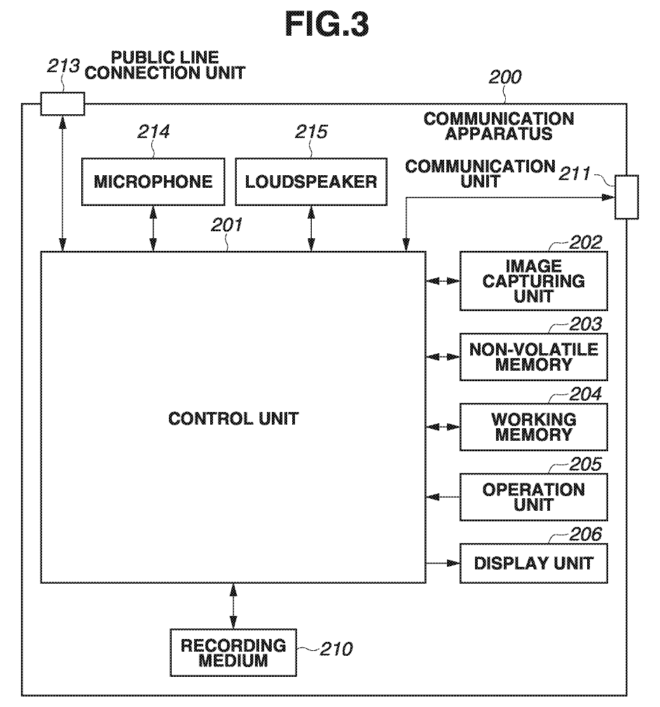

FIG. 3 is a block diagram illustrating a hardware configuration example of the communication apparatus 200 in the first embodiment.

Furthermore, while, here, a portable mobile terminal is described as an example of the communication apparatus 200, the communication apparatus 200 is not limited to this. For example, the communication apparatus 200 can be a digital video camera with a wireless function, a tablet device, or a personal computer.

A control unit 201 controls each unit of the communication apparatus 200 according to an input signal or a program described below. Furthermore, instead of the control unit 201 controlling the entire communication apparatus 200, a plurality of pieces of hardware can share processing to control the entire communication apparatus 200.

An image capturing unit 202 converts subject light imaged by a lens included in the image capturing unit 202 into an electrical signal, performs, for example, noise reduction processing on the electrical signal to generate digital data, and outputs the digital data as moving image data. The moving image data obtained by image capturing is temporarily stored in a buffer memory, is then subjected to predetermined arithmetic operation by the control unit 201, and is recorded on a recording medium 210.

A non-volatile memory 203 is an electrically erasable and recordable non-volatile memory. On the non-volatile memory 203, an operating system (OS) which is basic software which the control unit 201 executes and an application which implements an applicative function in cooperation with the OS are recorded.

Moreover, in the first embodiment, in the non-volatile memory 203, a transfer application which communicates with the image capturing apparatus 100 and the server 300 (hereinafter referred to as a "transfer app") is stored.

A working memory 204 is used as, for example, an image displaying memory for a display unit 206 and a working area for the control unit 201.

An operation unit 205 is used to receive an instruction to the communication apparatus 200 from the user. The operation unit 205 includes operation members such as a power button which is used for the user to issue an instruction for powering-on and powering-off of the communication apparatus 200 and a touch panel formed on the display unit 206.

The display unit 206 performs, for example, displaying of moving image data and displaying of characters for an interactive operation. Furthermore, the communication apparatus 200 does not necessarily need to include the display unit 206. The communication apparatus 200 may be able to connect to the internal or external display unit 206 and may include at least a display control function which controls a displaying operation of the display unit 206.

The recording medium 210 is capable of recording thereon moving image data output from the image capturing unit 202.

The recording medium 210 can be configured to be attachable to and detachable from the communication apparatus 200 or can be incorporated in the communication apparatus 200. Thus, the communication apparatus 200 may have a method for accessing at least the recording medium 210.

A communication unit 211 is an interface used to connect to an external apparatus. The communication apparatus 200 in the first embodiment is able to exchange data with the image capturing apparatus 100 and the server 300. In the first embodiment, the communication unit 211 is an antenna, and the control unit 201 is able to connect to the image capturing apparatus 100 via the antenna. Furthermore, the connection to the image capturing apparatus 100 and the server 300 can be direct connection or connection using an access point. The protocol to be used to communicate data can be, for example, Picture Transfer Protocol over Internet Protocol (PTP/IP) using a wireless LAN.

Moreover, the communication unit 211 includes a USB interface for communicating with an external apparatus by a USB cable. Furthermore, the communication with an external apparatus is not limited to this. For example, the communication unit 211 can include a wireless communication module such as an infrared communication module, a Bluetooth^{®} communication module, or a wireless USB module.

A public line connection unit 213 is an interface which is used for performing public wireless communication.

The communication apparatus 200 enables the user to talk on the phone with other equipment via the public line connection unit 213. On this occasion, the control unit 201 performs inputting and outputting of an audio signal via a microphone 214 and a loudspeaker 215, thus implementing telephone call.

The communication apparatus 200 in the first embodiment is able to perform exchange of data with the server 300 via the public line connection unit 213. The public line connection unit 213 is an antenna, and the control unit 201 is able to connect to a public line via the antenna. Furthermore, the communication unit 211 and the public line connection unit 213 can be integrated into one antenna. Moreover, generally, the communication performed via the communication unit 211 is faster in communication speed than the communication performed via a public line. Therefore, in the communication apparatus 200 in the first embodiment, in a state in which telephone call is not being performed, the communication performed via the communication unit 211 is prioritized.

Thus far is the description of the communication apparatus 200.

### Description of Chunk Recording File

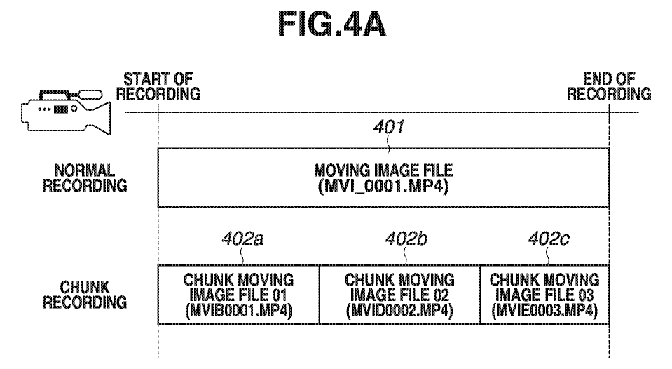

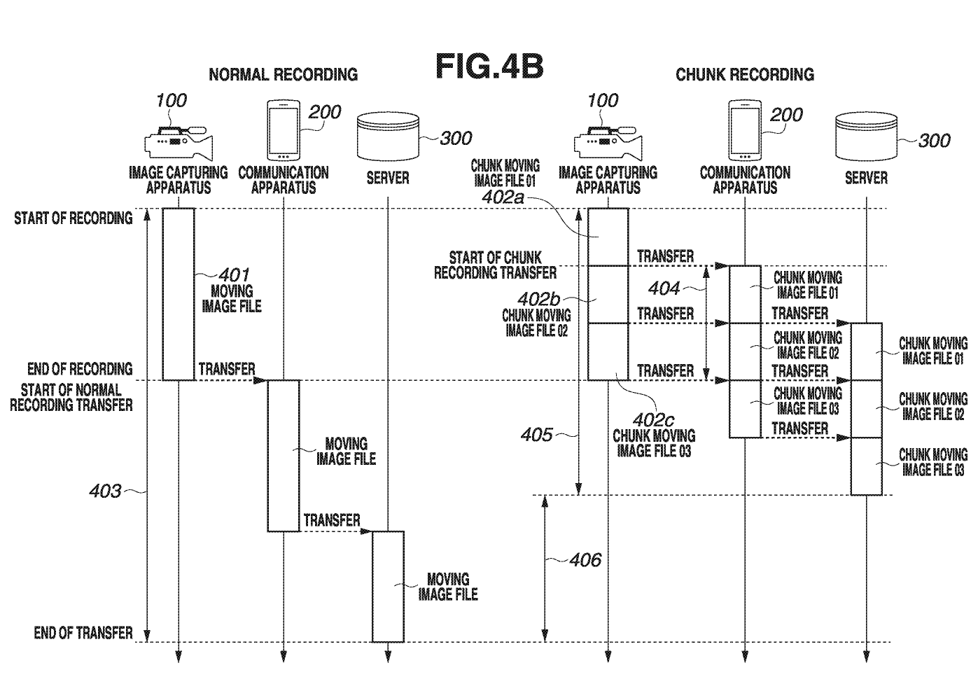

Next, two methods in which the image capturing apparatus 100 in the first embodiment records a moving image file with a low resolution or low bit rate in the MP4 file format on the recording medium 110 are described with reference to FIG. 4A.

In response to the user pressing the release switch 105a of the image capturing apparatus 100, recording starts, and, in response to the user pressing the release switch 105a again, recording ends.

The first method is normal recording for recording a moving image file with the same recording time as that for a main moving image file. A moving image file 401 has a recording time from the start of recording to the end of recording. Thus, the normal recording is assumed to be a recording method for generating one moving image file during a period from the start of recording to the end of recording.

In the first embodiment, for example, the moving image file 401 is a moving image file recorded with a file name having a prefix of "MVI_1" followed by four figures and an extension appended thereto. For example, the file name is expressed as "MVI_0001.MP4".

Next, the second method is chunk recording for progressively recording small divided moving image files at a timing at which a predetermined time has elapsed during recording. In the first embodiment, each of small divided moving image files in the case of the chunk recording is referred to as a "chunk moving image file". Here, the chunk moving image file is an example of divided data.

For example, when 30 seconds has elapsed from the start of recording or the timing at which a preceding chunk moving image file has been generated, the image capturing apparatus 100 generates a chunk moving image file. Specifically, the control unit 201 generates a chunk moving image file 402a when 30 seconds has elapsed from the start of recording. Additionally, the control unit 201 generates a chunk moving image file 402b when 30 seconds has elapsed from the timing at which the chunk moving image file 402a has been generated. In the example illustrated in FIG. 4A, the image capturing apparatus 100 is recording chunk moving image files at intervals of 30 seconds up to the time of the chunk moving image file 402b. When recording ends in response to the user pressing the release switch 105a, the image capturing apparatus 100 generates a chunk moving image file 402c having a time from the timing at which the chunk moving image file 402b has been generated to the time at which recording has ended.

In the first embodiment, for example, a file name which is used for the chunk recording is assumed to be expressed as follows. The chunk moving image file 402a, which is generated first, is assigned a file name "MVIB0001.MP4", in which the fourth character following "MVI" is set as "B" in such a way as to be identified as a leading moving image file (e.g., obtained at the time of start of recording). The chunk moving image file 402b, which is generated next, is assigned a file name "MVID0002.MP4", in which the fourth character following "MVI" is set as "D" in such a way as to be identified as a middle moving image file. The chunk moving image file 402c, which is generated last, is assigned a file name "MVIE0003.MP4", in which the fourth character following "MVI" is set as "E" in such a way as to be identified as the last moving image file (e.g., obtained at the time of end of recording).

In the first embodiment, instruction rules for sorting the fourth character included in a file name as mentioned above are used to determine which of the normal recording and the chunk recording is performed. Moreover, with regard to a chunk moving image file which is generated at the time of end of recording in chunk recording, setting the fourth character in a file name thereof as "E" is used to determine whether the chunk moving image file is the last moving image file. Furthermore, a moving image file which is composed of chunk moving image files from the chunk moving image file 402a, which is generated first, to the chunk moving image file 402c, which is generated last, is an example of a data group.

Next, with regard to a case where a moving image file is transferred from the image capturing apparatus 100 to the server 300 via the communication apparatus 200, advantageous effects to be obtained by performing chunk recording serving as the second method are described with reference to FIG. 4B.

A moving image file in the case of the normal recording is not able to be transmitted during the process of recording and, therefore, requires a recording time for a moving image file 401 and, in addition thereto, a transmission time for the moving image file 401. A time 403 illustrated in FIG. 4B represents a time required from the start of the normal recording to the completion of transfer of the moving image file 401.

With regard to a moving image file in the case of the chunk recording, the image capturing apparatus 100 is able to sequentially transmit chunk moving image files which have been generated during the process of recording. For example, when the chunk moving image file 402a has been generated, the image capturing apparatus 100 is able to transfer the chunk moving image file 402a even during the process of recording. Referring to FIG. 4B, the image capturing apparatus 100 is able to start transfer earlier by a difference time 404 than a recording time for the moving image file 401. A time 405 is a time required from the start of the chunk recording to the completion of transmission of the chunk moving image files. In this way, the advantage is that a transfer time 405 for the chunk recording is completed earlier by a difference time 406 than a transfer time 403 for the normal recording.

### Screen Explanation of Transfer App

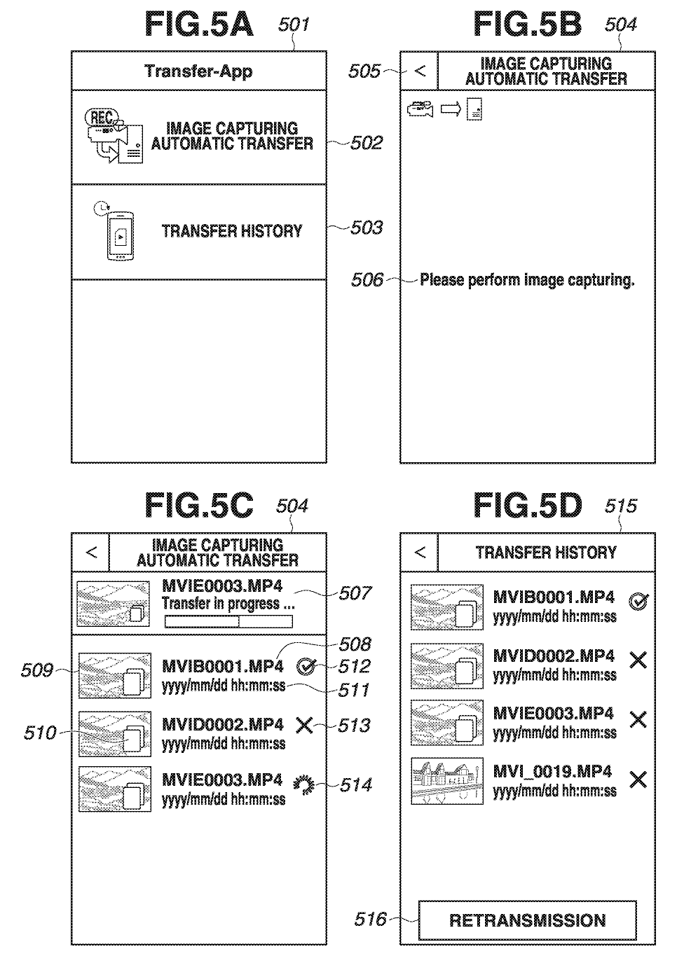

Next, aspects of the transfer app in the first embodiment are described with reference to FIGS. 5A, 5B, 5C, and 5D. FIGS. 5A to 5D are schematic diagrams illustrating display statuses and functions of an operation screen of the transfer app. Here, in response to the transfer app being caused to operate by the control unit 201, the control unit 201 displays a screen illustrated in FIG. 5A on the display unit 206.

Referring to FIG. 5A, a function selection screen 501 is a screen which is displayed after the transfer app is launched in a state in which the communication apparatus 200 is currently connected to the image capturing apparatus 100.

The function selection screen 501 is composed of an image capturing automatic transfer button 502 and a transfer history button 503. In response to the image capturing automatic transfer button 502 being pressed, the function selection screen 501 transitions to an image capturing automatic transfer screen 504. Moreover, in response to the transfer history button 503 being pressed, the function selection screen 501 transitions to a transfer history screen 515.

Referring to FIG. 5B, the image capturing automatic transfer screen 504 is a screen for displaying a file which the image capturing apparatus 100 has transferred to the server 300 via the communication apparatus 200.

According to the first embodiment, in response to transitioning to the image capturing automatic transfer screen 504, the communication apparatus 200 enters into a state of being able to receive a notification of generation of a moving image file from the image capturing apparatus 100.

The image capturing automatic transfer screen 504 includes a back button 505 for returning to the preceding screen. The image capturing automatic transfer screen 504 further includes an initial screen 506, which is being displayed during a period in which transfer is not yet performed.

Referring to FIG. 5C, the image capturing automatic transfer screen 504 has a screen structure in transferring chunk moving image files recorded by the image capturing apparatus 100.

The image capturing automatic transfer screen 504 includes a status region 507 indicating a chunk moving image file which is in the process of transfer and a status of the chunk moving image file. Below the status region 507, a chunk moving image file which has been already transferred, a chunk moving image file which is in the process of transfer, and a chunk moving image file which has failed in being transferred are shown.

A character string 508 indicates the file name of a chunk moving image file.

A component 509 is provided to display a thumbnail image of the file, thus displaying a thumbnail image recorded in a moving image file corresponding to the file name 508.

An icon 510 indicates that the moving image file has been recorded with the chunk recording.

A character string 511 indicates the image capturing date and time of a chunk moving image file of which the image capturing apparatus 100 has started recording.

A transfer completion icon 512 is displayed when processing for transfer of the chunk moving image file has been completed.

A transfer failure icon 513 is displayed when processing for transfer of the chunk moving image file has failed.

A transfer in-progress icon 514 indicates that processing for transfer of the chunk moving image file is in progress.

Referring to FIG. 5D, the transfer history screen 515 is a screen for displaying a transfer history indicating that the communication apparatus 200 has transferred the moving image file to the server 300.

A retransmission button 516 is provided to retransmit a moving image file on which the communication apparatus 200 has failed in processing of transfer to the server 300. In response to the retransmission button 516 being pressed, the communication apparatus 200 sequentially starts retransfer of moving image files for which the transfer failure icon 513 has been displayed.

In the case of transferring a moving image file recorded with the normal recording by the image capturing apparatus 100 from the communication apparatus 200 to the server 300, if the communication apparatus 200 is currently connected to the image capturing apparatus 100, the communication apparatus 200 receives the moving image file from the image capturing apparatus 100 and transfers the received moving image file to the server 300.

In the case of transferring chunk moving image files recorded with the chunk recording by the image capturing apparatus 100 from the communication apparatus 200 to the server 300, the communication apparatus 200 transfers chunk recording files stored in a cache region of the working memory 204 to the server 300. The communication apparatus 200 deletes, from the cache region of the working memory 204, a chunk moving image file the transfer of which to the server 300 has been completed.

This enables, in a case where the moving image file to be transferred from the communication apparatus 200 to the server 300 is a chunk moving image file, promptly transferring, to the server 300, chunk moving image files which have been preliminarily stored in the cache region of the working memory 204.

Furthermore, while, in the above description, in a case where the transfer of a chunk moving image file to the server 300 has been completed, the communication apparatus 200 deletes the chunk moving image file from the cache region of the working memory 204, the first embodiment is not limited to this.

For example, the communication apparatus 200 can delete a chunk moving image file which has been preliminarily stored in the cache region of the working memory 204, if a given period of time has elapsed.

### Processing Sequence between Image Capturing Apparatus 100, Communication Apparatus 200, and Server 300

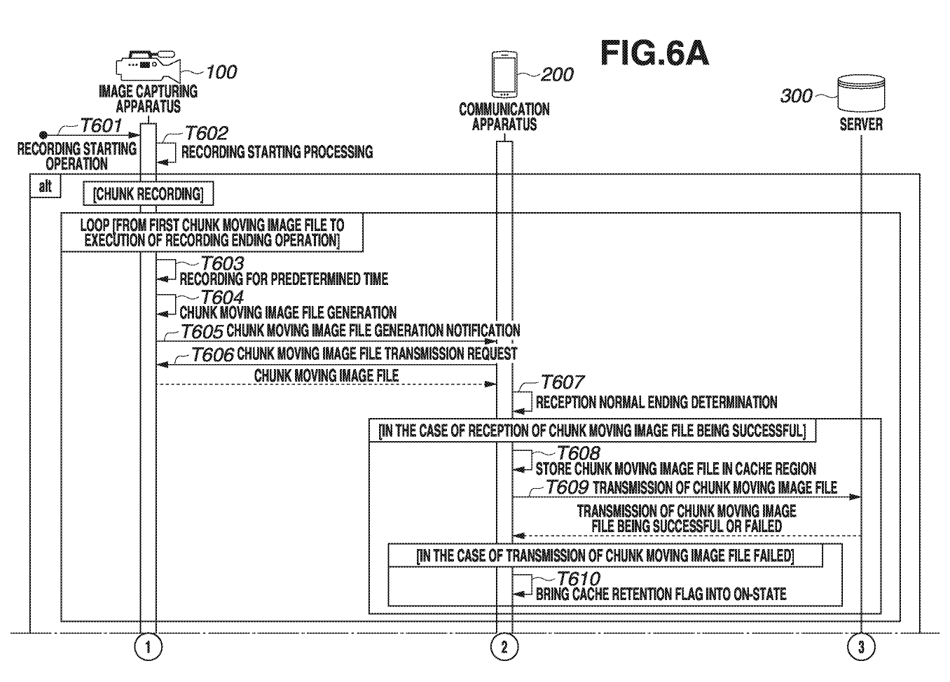

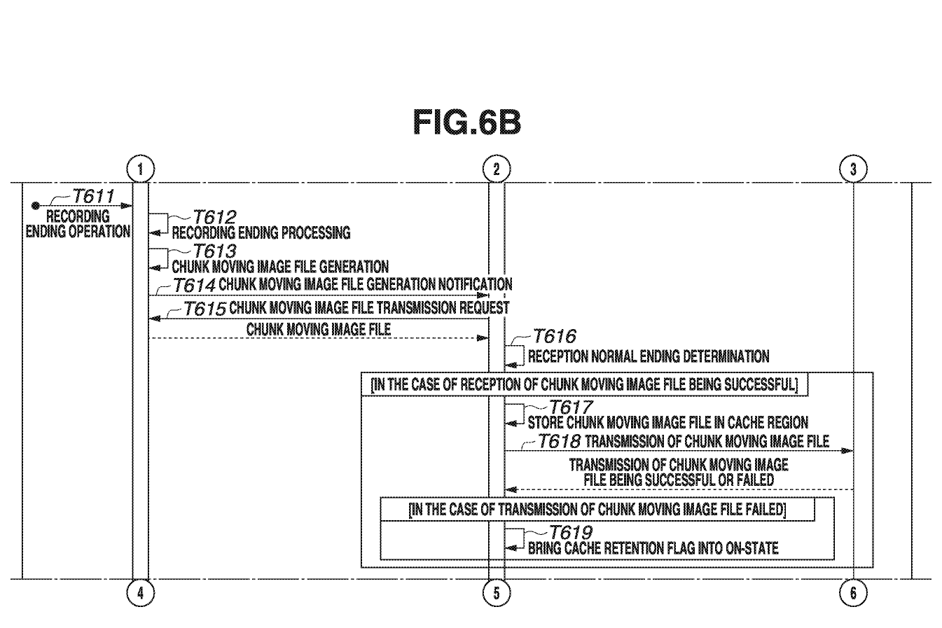

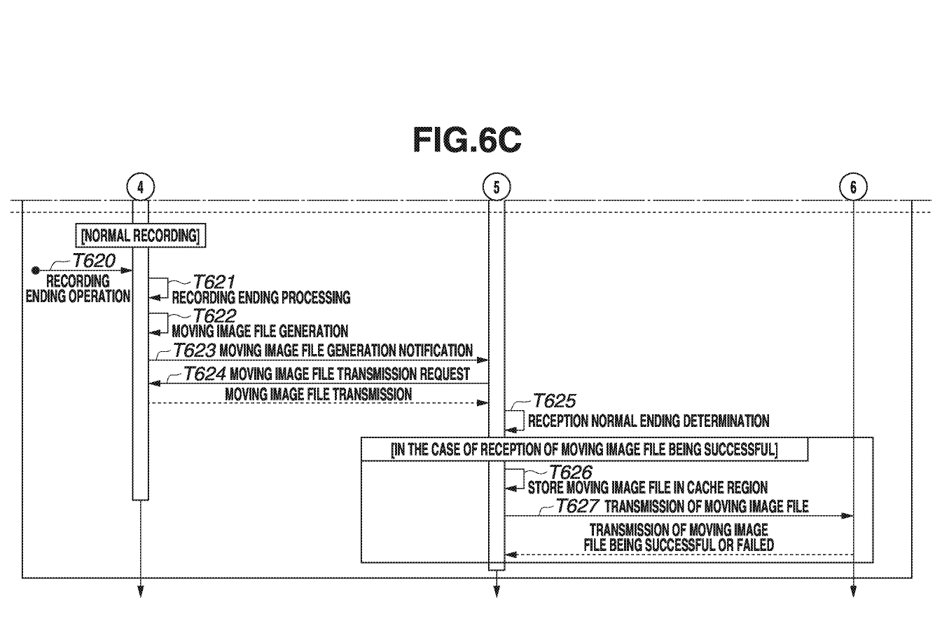

Next, processing for automatically transferring a moving image file recorded by the image capturing apparatus 100 to the server 300 via the communication apparatus 200 is described with reference to FIGS. 6A, 6B, and 6C.

FIGS. 6A to 6C are diagrams illustrating a processing sequence which is executed in the transfer of a moving image file between the image capturing apparatus 100, the communication apparatus 200, and the server 300.

The description of the processing illustrated in FIGS. 6A to 6C is directed to processing which is performed after the function selection screen 501 has transitioned to the image capturing automatic transfer screen 504 and the communication apparatus 200 has come into a state of being able to receive a notification of generation of a moving image file from the image capturing apparatus 100.

In step T601, in a state in which the transfer app of the communication apparatus 200 has transitioned to displaying of the image capturing automatic transfer screen 504 illustrated in FIG. 5B, in response to the release switch 105a of the image capturing apparatus 100 being pressed by the user, the image capturing apparatus 100 receives a recording starting operation.

In step T602, the image capturing apparatus 100 starts recording of a moving image file.

In step T603 to step T611, in a case where the recording method of the image capturing apparatus 100 is currently set to the chunk recording, the image capturing apparatus 100, the communication apparatus 200, and the server 300 perform loop processing until the user presses the release switch 105a of the image capturing apparatus 100.

In step T603, the image capturing apparatus 100 waits for recording with a predetermined time. When the predetermined time has elapsed, then in step T604 illustrated in FIG. 6A, the image capturing apparatus 100 generates a chunk moving image file.

Upon the generation of the chunk moving image file in step T604, then in step T605 illustrated in FIG. 6A, the image capturing apparatus 100 transmits a notification of generation of the chunk moving image file to the communication apparatus 200 via the communication unit 111.

Upon receiving the notification of generation of the chunk moving image file in step T605, the communication apparatus 200 acquires the file name of the chunk moving image file. In the first embodiment, the acquired file name is able to be used to determine whether the moving image file concerned is a chunk moving image file. For example, in the first embodiment, in a case where the fourth character is "B", "D", or "E", the communication apparatus 200 determines that the moving image file concerned is a chunk moving image file. Furthermore, the notification of generation is an example of notification information.

In step T606, the communication apparatus 200 transmits a chunk moving image file transmission request to the image capturing apparatus 100 via the communication unit 211, and thus acquires the chunk moving image file from the image capturing apparatus 100.

In step T607, the communication apparatus 200 determines whether the reception of the chunk moving image file, which is transmitted from the image capturing apparatus 100, has normally ended. If the reception of the chunk moving image file is successful, then in step T608, the communication apparatus 200 stores the chunk moving image file in the cache region of the working memory 204.

In step T609, the communication apparatus 200 transmits the chunk moving image file to the server 300 via the communication unit 211, and then acquires, from the server 300, a status indicating whether the transmission of the chunk moving image file is successful or failed.

If the communication apparatus 200 has failed in transmitting the chunk moving image file to the server 300, then in step T610, the communication apparatus 200 brings a cache retention flag into an on-state. Bringing a cache retention flag into an on-state refers to, for example, storing the file name of a chunk moving image file the transmission of which to the server 300 failed in the working memory 204 of the communication apparatus 200.

In step T611 illustrated in FIG. 6B, in response to the release switch 105a of the image capturing apparatus 100 being pressed by the user, the image capturing apparatus 100 receives a recording ending operation and exits the loop processing, and, then in step T612, the image capturing apparatus 100 performs recording ending processing.

In step T613, the image capturing apparatus 100 generates the last chunk moving image file. Step T614 to step T619 are processing operations equivalent to those in step T605 to step T610 and are, therefore, omitted from description.

Next, a sequence which is performed in a case where the recording method currently set to the image capturing apparatus 100 is the normal recording is described.

In step T620 illustrated in FIG. 6C, in response to the release switch 105a of the image capturing apparatus 100 being pressed by the user, the image capturing apparatus 100 receives a recording ending operation and, then in step T621, the image capturing apparatus 100 performs recording ending processing.

In step T622, in response to the recording ending processing being performed in step T621, the image capturing apparatus 100 generates a moving image file.

In response to the moving image file being generated in step T622, then in step T623, the image capturing apparatus 100 transmits a notification of generation of the moving image file to the communication apparatus 200 via the communication unit 111.

Upon receiving the notification of generation of the moving image file in step T623, the communication apparatus 200 acquires the file name of the moving image file. In step T624, the communication apparatus 200 transmits a moving image file transmission request to the image capturing apparatus 100 via the communication unit 211, and then acquires the moving image file from the image capturing apparatus 100.

In step T625, the communication apparatus 200 determines whether the reception of the moving image file, which is transmitted from the image capturing apparatus 100, has normally ended. If the reception of the moving image file is successful, then in step T626, the communication apparatus 200 stores the moving image file in the cache region of the working memory 204.

In step T627, the communication apparatus 200 transmits the moving image file to the server 300 via the communication unit 211, and then acquires, from the server 300, a status indicating whether the transmission of the moving image file is successful or failed.

Thus far is the description of the processing sequence, which is executed between the image capturing apparatus 100, the communication apparatus 200, and the server 300.

As mentioned above, the main purpose of the transfer app in the first embodiment is using the above-described function to automatically transfer a moving image file recorded by the image capturing apparatus 100 to the server 300 via the communication apparatus 200.

However, there is a case where, when transmitting a moving image file which the communication apparatus 200 has received from the image capturing apparatus 100 to the server 300, the transfer app fails in transmitting some chunk moving image files out of a serial file group, from a beginning chunk moving image file to an ending chunk moving image file.

In that case, there is an issue in which the communication apparatus 200 needs to re-acquire, from the image capturing apparatus 100, chunk moving image files the transfer of which failed and transmit the chunk moving image files to the server 300 again, thus requiring a lot of time and effort.

The first embodiment is directed to, in a case where, in the image capturing automatic transfer function, the communication apparatus 200 has failed in transmitting chunk moving image files to the server 300 as mentioned above, preventing the communication apparatus 200 from re-acquiring the chunk moving image files from the image capturing apparatus 100.

### Flow of Processing for Communication Apparatus 200 concerning Transmission of Chunk Moving Image File

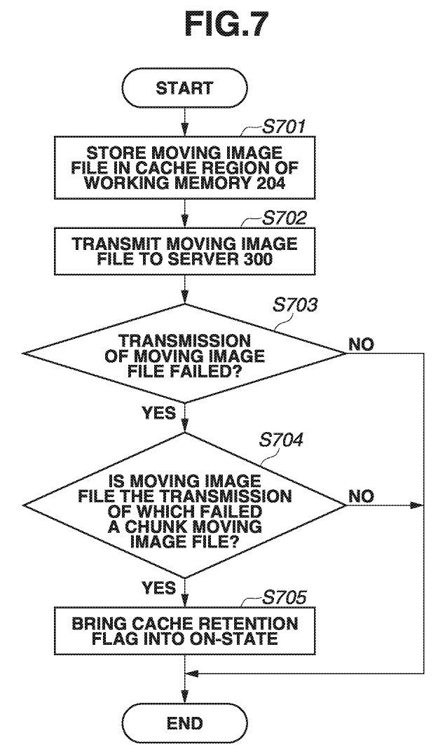

Next, a flow of processing which the communication apparatus 200 performs concerning the transmission of a chunk moving image file in the first embodiment is described with reference to FIG. 7.

The flow of processing illustrated in FIG. 7 is implemented by the control unit 201 controlling each unit of the communication apparatus 200 according to an input signal or a program.

The flow of processing illustrated in FIG. 7 is started at timing when, in the state in which the image capturing apparatus 100 has started recording of a moving image file, the communication apparatus 200 has succeeded in receiving the moving image file transmitted from the image capturing apparatus 100. Furthermore, it is assumed that, when the processing illustrated in FIG. 7 is started, the transfer app is launched in the communication apparatus 200 and is in the state of displaying the image capturing automatic transfer screen 504 illustrated in FIG. 5B.

In step S701, the control unit 201 of the communication apparatus 200 stores the moving image file received from the image capturing apparatus 100 in the cache region of the working memory 204.

In step S702, the control unit 201 transmits the moving image file to the server 300 via the communication unit 211.

In step S703, the control unit 201 determines whether the transmission of the moving image file failed. This determination is performed based on receiving a status indicating whether the transmission of the moving image file failed from the server 300.

If it is determined that the transmission of the moving image file failed (YES in step S703), the control unit 201 advances the processing to step S704. On the other hand, if it is determined that the transmission of the moving image file is successful (NO in step S703), the control unit 201 ends the flow of processing illustrated in FIG. 7.

In step S704, the control unit 201 determines whether the moving image file the transmission of which failed is a chunk moving image file, based on the moving image file name already acquired at the time of reception of a notification of generation of the moving image file transmitted from the image capturing apparatus 100. If it is determined that the moving image file the transmission of which failed is a chunk moving image file (YES in step S704), the control unit 201 advances the processing to step S705. On the other hand, if it is determined that the moving image file the transmission of which failed is not a chunk moving image file (NO in step S704), the control unit 201 ends the flow of processing illustrated in FIG. 7.

In step S705, the control unit 201 brings a cache retention flag into an on-state.

According to the above-described processing illustrated in FIG. 7, in a case where the moving image file the transmission of which to the server 300 failed is a chunk moving image file, bringing the cache retention flag into an on-state enables storing the chunk moving image file the transmission of which failed.

### Flow of Processing for Communication Apparatus 200 concerning Deletion of Moving Image File

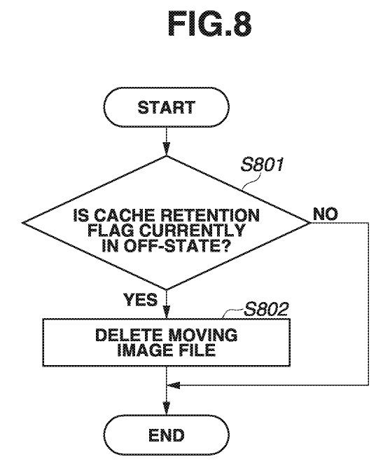

Next, a flow of processing which the communication apparatus 200 performs concerning the deletion of a moving image file in the first embodiment is described with reference to FIG. 8.

The flow of processing illustrated in FIG. 8 is started at timing when the transfer app of the communication apparatus 200 has transitioned from the state of displaying the image capturing automatic transfer screen 504 illustrated in FIG. 5B to displaying of another screen. For example, at timing when, in response to the user pressing the back button 505 for returning to the preceding screen illustrated in FIG. 5B, the transfer app has transitioned to displaying of the function selection screen 501, the present processing is started.

In step S801, the control unit 201 of the communication apparatus 200 determines whether the cache retention flag is currently in an off-state.

If it is determined that the cache retention flag is currently in an off-state (YES in step S801), the control unit 201 advances the processing to step S802. On the other hand, if it is determined that the cache retention flag is not currently in an off-state (NO in step S801), the control unit 201 ends the present processing.

In step S802, the control unit 201 deletes a moving image file which has previously been stored in the cache region of the working memory 204.

According to the above-described processing illustrated in FIG. 8, it is possible to delete a moving image file the cache retention flag of which is in an off-state. Thus, the control unit 201 deletes a moving image file the transmission of which to the server 300 is successful from the cache region of the working memory 204 of the communication apparatus 200.

As described above, in the first embodiment, the communication apparatus 200 receives a moving image file which has been recorded by the image capturing apparatus 100. Then, the communication apparatus 200 determines whether the moving image file concerned is a chunk moving image file out of a serial file group from a beginning chunk moving image file to an ending chunk moving image file. If it is determined that the moving image file concerned is a chunk moving image file, when the transmission of the chunk moving image file to the server 300 failed, the communication apparatus 200 stores the chunk moving image file in the cache region of the working memory 204.

Accordingly, when retransmitting a chunk moving image file to the server 300, the communication apparatus 200 no longer needs to re-acquire, from the image capturing apparatus 100, a chunk moving image the transmission of which to the server 300 failed. Thus, it is possible to shorten a time required for the retransmission of a chunk moving image file the transmission of which to the server 300 failed.

In the description of the first embodiment, the processing for deleting a moving image file which has previously been stored in the cache region of the working memory 204 is performed at timing when the transfer app of the communication apparatus 200 has transitioned from the state of displaying the image capturing automatic transfer screen 504 illustrated in FIG. 5B to displaying of another screen. However, the first embodiment is not limited to the above-mentioned example. For example, the above-described processing can be performed at timing when, in the state in which the image capturing apparatus 100 and the communication apparatus 200 are connected to each other via the communication unit 111 and the communication unit 211, the communication has been cut off.

Moreover, the above-described processing can be performed at timing when the user has operated the operation unit 205 of the communication apparatus 200 to perform another operation.

### Second Embodiment

Next, a second embodiment is described.

In the above-described first embodiment, with regard to the transfer app, the communication apparatus 200 receives a moving image file recorded by the image capturing apparatus 100 and then determines whether the received moving image file is a chunk moving image file. If it is determined that the received moving image file is a chunk moving image file, when the transmission of the chunk moving image file to the server 300 failed, the communication apparatus 200 keeps storing the chunk moving image file in the cache region of the working memory 204.

In the second embodiment, a method in which, when having failed in receiving a chunk moving image file transmitted from the image capturing apparatus 100, the communication apparatus 200 automatically re-acquires the chunk moving image file the reception of which failed from the image capturing apparatus 100 at timing available for acquisition is described.

Furthermore, in the second embodiment, the image capturing apparatus 100, the communication apparatus 200, the server 300, and the system configuration are similar to those in the first embodiment and are, therefore, omitted from description.

### List of Failed Chunk Moving Image File Information

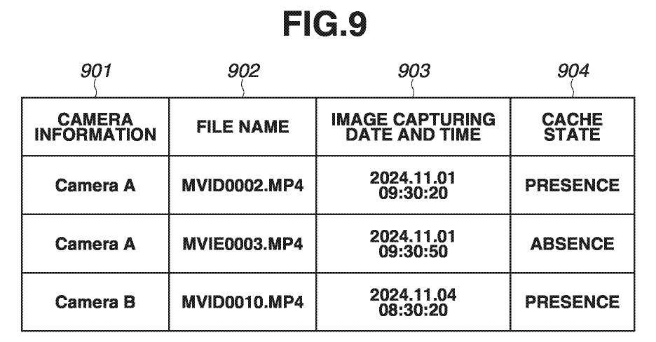

FIG. 9 is a diagram schematically showing a list of information indicating that the communication apparatus 200 has failed in receiving a chunk moving image file transmitted from the image capturing apparatus 100 or information indicating that the communication apparatus 200 has failed in transmitting a chunk moving image file to the server 300 in the second embodiment.

Referring to FIG. 9, column 901 represents camera information. The camera information in the second embodiment is, for example, information which is managed with a model identification (ID) of the image capturing apparatus 100 or a serial number of the image capturing apparatus 100.

Referring to FIG. 9, column 902 represents a file name of a chunk moving image file which the communication apparatus 200 has failed in receiving from the image capturing apparatus 100 or has failed in transmitting to the server 300.

Referring to FIG. 9, column 903 represents image capturing date and time, which is a time recorded at which, in the image capturing apparatus 100, the generation of a chunk moving image file has been started.

Referring to FIG. 9, column 904 represents a cache state indicating whether a chunk moving image file is currently stored in the cache region of the working memory 204. Since, when having failed in transmitting a chunk moving image file to the server 300, the communication apparatus 200 stores the chunk moving image file in the cache region of the working memory 204, the communication apparatus 200 sets the cache state as presence. Moreover, since, when having failed in receiving a chunk moving image file transmitted from the image capturing apparatus 100, the communication apparatus 200 is unable to store the chunk moving image file in the cache region of the working memory 204, the communication apparatus 200 sets the cache state as absence.

Preparing the above-mentioned list of failed chunk moving image file information enables appropriately managing information indicating whether the communication apparatus 200 has failed in receiving a chunk moving image file from the image capturing apparatus 100 or has failed in transmitting a chunk moving image file to the server 300 as well as the camera information about the camera serving as a receiving source.

Furthermore, while, in the second embodiment, the camera information is assumed to be a model ID of the image capturing apparatus 100 or a serial number of the image capturing apparatus 100, the second embodiment is not limited to this. For example, the camera information can be other information as long as it is information available for uniquely identifying the image capturing apparatus 100.

### Processing Sequence between Image Capturing Apparatus 100, Communication Apparatus 200, and Server 300

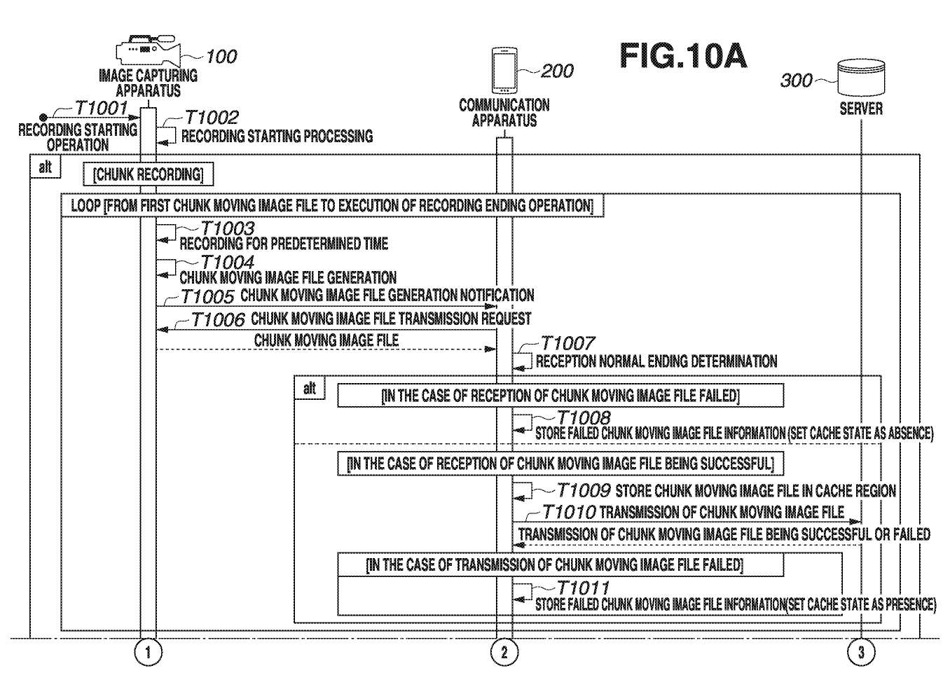

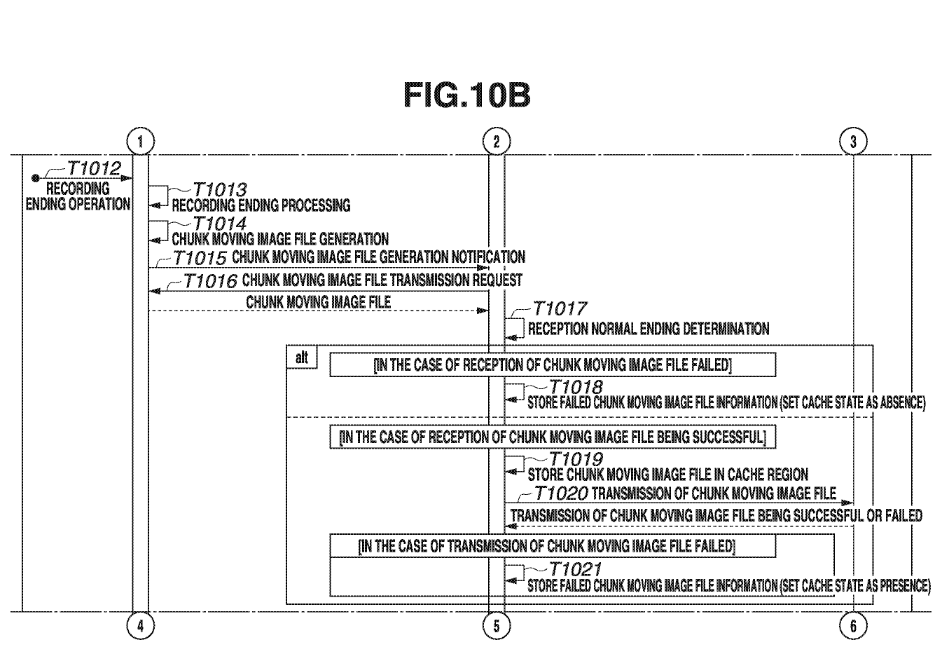

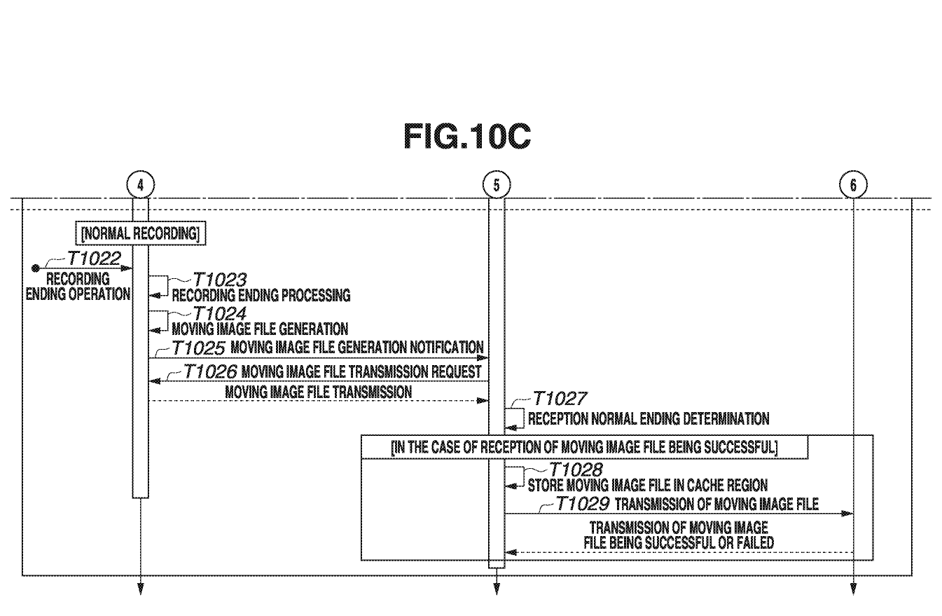

Next, processing for automatically transferring a moving image file recorded by the image capturing apparatus 100 to the server 300 via the communication apparatus 200 in the second embodiment is described with reference to FIGS. 10A, 10B, and 10C.

FIGS. 10A to 10C are diagrams illustrating a processing sequence which is executed in the transfer of a moving image file between the image capturing apparatus 100, the communication apparatus 200, and the server 300.

The description of the processing illustrated in 10A and 10B is directed to processing which is performed after the function selection screen 501 has transitioned to the image capturing automatic transfer screen 504 and the communication apparatus 200 has come into a state of being able to receive a notification of generation of a moving image file from the image capturing apparatus 100.

Furthermore, step T1001 to step T1006 illustrated in FIG. 10A are processing operations equivalent to those in step T601 to step T606 described above illustrated in FIG. 6A and are, therefore, omitted from description.

In step T1007 illustrated in FIG. 10A, the communication apparatus 200 determines whether the reception of a chunk moving image file, which is transmitted from the image capturing apparatus 100 via the communication unit 211, has normally ended. At this time, the communication apparatus 200 branches processing which the control unit 201 thereof performs, depending on whether the reception of a chunk moving image file is successful.

If the reception of a chunk moving image file failed, then in step T1008, the communication apparatus 200 sets the cache state shown in column 904 illustrated in FIG. 9 as absence and stores the failed chunk moving image file information in the working memory 204. On the other hand, if the reception of a chunk moving image file is successful, then in step T1009, the communication apparatus 200 stores, in the cache region of the working memory 204, a chunk moving image file received from the image capturing apparatus 100 in response to a request transmitted to the image capturing apparatus 100 in step T1006.

In step T1010 illustrated in FIG. 10A, the communication apparatus 200 transmits the chunk moving image file to the server 300 via the communication unit 211, and then acquires, from the server 300, a status indicating whether the transmission of the chunk moving image file is successful or failed.

If the communication apparatus 200 has failed in transmitting the chunk moving image file to the server 300, then in step T1011, the communication apparatus 200 sets the cache state shown in column 904 illustrated in FIG. 9 as presence and stores the failed chunk moving image file information in the working memory 204.

Step T1012 to step T1016 are processing operations equivalent to those in step T612 to step T616 described above illustrated in FIG. 6B and are, therefore, omitted from description.

Moreover, step T1017 to step T1021 are processing operations equivalent to those in step T1007 to step T1011 described above illustrated in FIG. 10A and are, therefore, omitted from description.

Moreover, step T1022 to step T1029 are processing operations equivalent to those in step T620 to step T627 described above illustrated in FIG. 6C and are, therefore, omitted from description.

### Flow of Processing for Communication Apparatus 200 concerning Updating of Failed Chunk Moving Image File Information

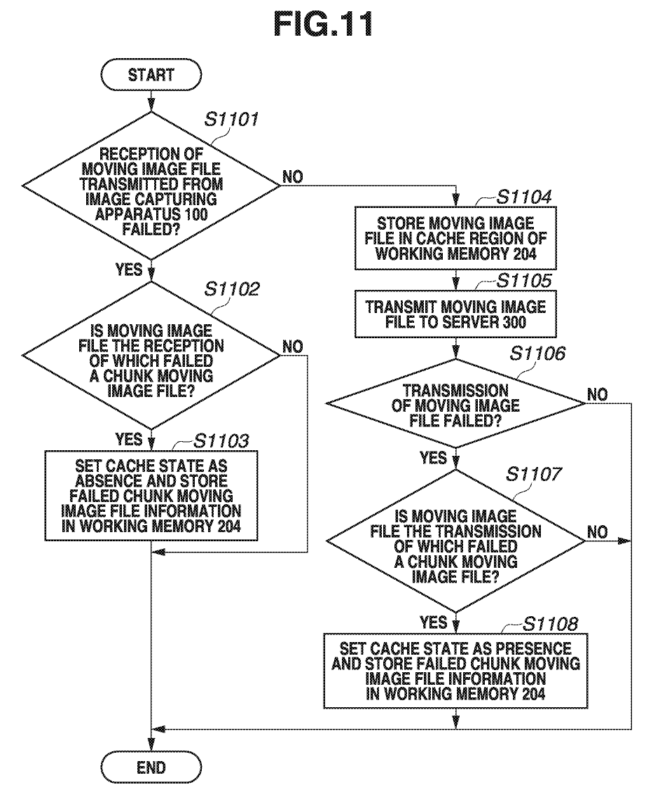

Next, a flow of processing which the communication apparatus 200 performs concerning the updating of failed chunk moving image file information in the second embodiment is described with reference to FIG. 11.

The flow of processing illustrated in FIG. 11 is started at timing when, in the state in which the image capturing apparatus 100 has started recording of a moving image file, the communication apparatus 200 has received a result of a moving image file transmission request which the communication apparatus 200 has transmitted to the image capturing apparatus 100.

In step S1101, the control unit 201 of the communication apparatus 200 determines whether the reception of a moving image file transmitted from the image capturing apparatus 100 failed.

If it is determined that the reception of a moving image file failed (YES in step S1101), the control unit 201 advances the processing to step S1102. On the other hand, if it is determined that the reception of a moving image file is successful (NO in step S1101), the control unit 201 advances the processing to step S1104.

In step S1102, the control unit 201 determines whether the moving image file the reception of which failed is a chunk moving image file, based on the moving image file name which has already been acquired at the time of reception of a notification of generation of the moving image file from the image capturing apparatus 100. If it is determined that the moving image file the reception of which failed is a chunk moving image file (YES in step S1102), the control unit 201 advances the processing to step S1103. On the other hand, if it is determined that the moving image file the reception of which failed is not a chunk moving image file (NO in step S1102), the control unit 201 ends the flow of processing illustrated in FIG. 11.

In step S1103, the control unit 201 sets the cache state shown in column 904 illustrated in FIG. 9 as absence and stores the failed chunk moving image file information in the working memory 204. At this time, the control unit 201 also stores the camera information about the image capturing apparatus 100, the file name of the chunk moving image file the reception of which failed, and the image capturing date and time together.

Furthermore, step S1104 to step S1106 are processing operations equivalent to those in step S701 to step S703 described above and are, therefore, omitted from description.

In step S1107, the control unit 201 determines whether the moving image file the transmission of which failed is a chunk moving image file, based on the moving image file name already acquired at the time of reception of a notification of generation of the moving image file transmitted from the image capturing apparatus 100. If it is determined that the moving image file the transmission of which failed is a chunk moving image file (YES in step S1107), the control unit 201 advances the processing to step S1108. On the other hand, if it is determined that the moving image file the transmission of which failed is not a chunk moving image file (NO in step S1107), the control unit 201 ends the flow of processing illustrated in FIG. 11.

In step S1108, the control unit 201 sets the cache state shown in column 904 illustrated in FIG. 9 as presence and stores the failed chunk moving image file information in the working memory 204. At this time, the control unit 201 also stores the camera information about the image capturing apparatus 100, the file name of the chunk moving image file the transmission of which failed, and the image capturing date and time together.

According to the above-described processing illustrated in FIG. 11, the control unit 201 of the communication apparatus 200 is able to store and update the cache state of the failed chunk moving image file information together with the camera information, the file name of the chunk moving image file, and the image capturing date and time.

This enables, with regard to a chunk moving image file, the communication apparatus 200 to appropriately manage information indicating whether the reception of the chunk moving image file from the image capturing apparatus 100 failed or the transmission of the chunk moving image file to the server 300 failed as well as camera information about the reception source.

### Flow of Processing for Communication Apparatus 200 concerning Deletion of Moving Image File

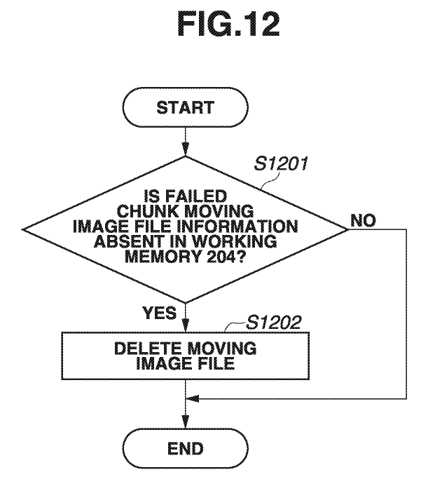

Next, a flow of processing which the communication apparatus 200 performs concerning the deletion of a moving image file in the second embodiment is described with reference to FIG. 12.

The flow of processing illustrated in FIG. 12 is started at timing when the transfer app of the communication apparatus 200 has transitioned from the state of displaying the image capturing automatic transfer screen 504 illustrated in FIG. 5B to displaying of another screen. For example, at timing when, in response to the user pressing the back button 505 for returning to the preceding screen illustrated in FIG. 5B, the transfer app has transitioned to displaying of the function selection screen 501, the present processing is started.

In step S1201 illustrated in FIG. 12, the control unit 201 of the communication apparatus 200 checks whether the failed chunk moving image file information is absent in the working memory 204.

If it is determined that the failed chunk moving image file information is absent in the working memory 204 (YES in step S1201), the control unit 201 advances the processing to step S1202. On the other hand, if it is determined that the failed chunk moving image file information is present in the working memory 204 (NO in step S1201), the control unit 201 ends the flow of processing illustrated in FIG. 12.

In step S1202, the control unit 201 deletes a moving image file which has previously been stored in the cache region of the working memory 204.

According to the above-described processing illustrated in FIG. 12, it is possible to delete a moving image file the failed chunk moving image file information about which is absent in the working memory 204. Thus, the control unit 201 deletes a moving image file the transmission of which to the server 300 is successful from the cache region of the working memory 204 of the communication apparatus 200.

### Processing Sequence after Establishment of Connection between Image Capturing Apparatus 100 and Communicating Apparatus 200

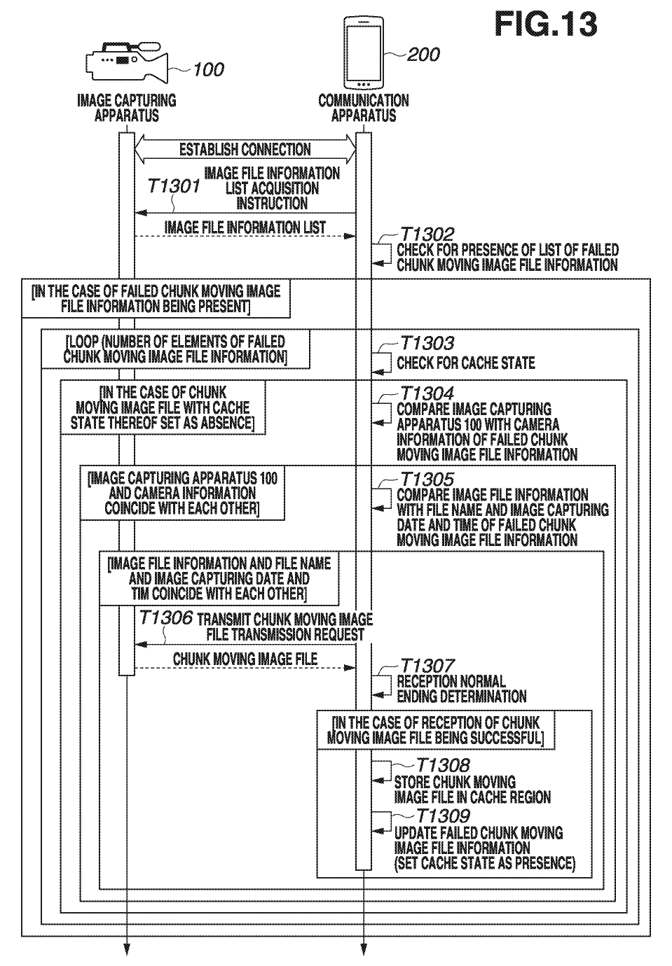

Next, processing in which, in the state in which the image capturing apparatus 100 and the communication apparatus 200 are connected to each other via the communication unit 111 and the communication unit 211, the communication apparatus 200 performs re-reception of a chunk moving image file the reception of which from the image capturing apparatus 100 failed in the second embodiment is described with reference to FIG. 13.

FIG. 13 is a diagram illustrating a processing sequence which is performed between the image capturing apparatus 100 and the communication apparatus 200 for re-reception of a chunk moving image file which the communication apparatus 200 has failed in receiving from the image capturing apparatus 100.

The description of the processing illustrated in FIG. 13 is directed to processing which is performed after the transfer app is launched in the communication apparatus 200 and the image capturing apparatus 100 and the communication apparatus 200 are connected to each other via the communication unit 111 and the communication unit 211.

In step T1301, the communication apparatus 200 transmits an image file information list acquisition instruction to the image capturing apparatus 100 via the communication unit 211, and then acquires an image file information list from the image capturing apparatus 100.

In step T1302, the communication apparatus 200 checks for the presence of a list of failed chunk moving image file information which is previously stored in the working memory 204. If the list of failed chunk moving image file information is present, then in step T1303 to step T1309, the image capturing apparatus 100 and the communication apparatus 200 perform loop processing a number of times corresponding to the number of elements included in the list of failed chunk moving image file information.

In step T1303, the communication apparatus 200 checks for the cache state shown in column 904 of the failed chunk moving image file information which is previously stored in the working memory 204.

In the case of a chunk moving image file with the cache state thereof set as absence, in step T1304, the communication apparatus 200 compares the image capturing apparatus 100 with the camera information shown in column 901 of the failed chunk moving image file information.

If the image capturing apparatus 100 and the camera information coincide with each other, then in step T1305, the communication apparatus 200 compares the image file information list acquired from the image capturing apparatus 100 in step T1301 with the file name shown in column 902 of the failed chunk moving image file information and the image capturing date and time shown in column 903 thereof.

If the image file information and the file name and image capturing date and time of the failed chunk moving image file information coincide with each other, then in step T1306, the communication apparatus 200 transmits a chunk moving image file transmission request to the image capturing apparatus 100 via the communication unit 211. Upon receiving the transmission request from the communication apparatus 200, the image capturing apparatus 100 transmits a chunk moving image file to the communication apparatus 200 via the communication unit 111.

In step T1307, the communication apparatus 200 determines whether the reception of the chunk moving image file, which is transmitted from the image capturing apparatus 100, has normally ended. If the reception of the chunk moving image file is successful, then in step T1308, the communication apparatus 200 stores the chunk moving image file in the cache region of the working memory 204.

In step T1309, the communication apparatus 200 updates the cache state shown in column 904 of the failed chunk moving image file information corresponding to the chunk moving image file received from the image capturing apparatus 100 in step T1306 to presence. Then, the communication apparatus 200 stores the updated failed chunk moving image file information in the working memory 204.

### Processing Flow for Communication Apparatus 200 Concerning Re-reception of Chunk Moving Image File

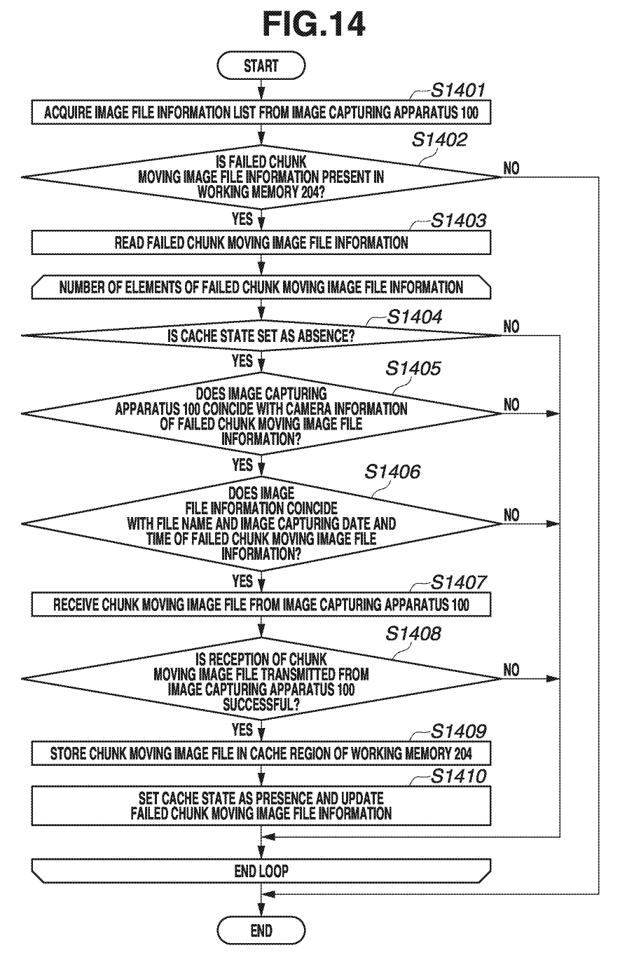

Next, a processing flow for the communication apparatus 200 concerning the re-reception of a chunk moving image file in the second embodiment is described with reference to FIG. 14.

The flow of processing illustrated in FIG. 14 is started at timing when the transfer app is launched in the communication apparatus 200 and the image capturing apparatus 100 and the communication apparatus 200 have come into the state of being connected to each other via the communication unit 111 and the communication unit 211.

In step S1401 illustrated in FIG. 14, the control unit 201 of the communication apparatus 200 acquires an image file information list from the image capturing apparatus 100.

In step S1402, the control unit 201 checks whether the failed chunk moving image file information is present in the working memory 204 of the communication apparatus 200. If it is determined that the failed chunk moving image file information is present (YES in step S1402), the control unit 201 advances the processing to step S1403. On the other hand, if it is determined that the failed chunk moving image file information is absent (NO in step S1402), the control unit 201 ends the flow of processing illustrated in FIG. 14.

In step S1403, the control unit 201 reads the failed chunk moving image file information from the working memory 204.

In processing operations in step S1404 to step S1410, the control unit 201 performs loop processing a number of times corresponding to the number of elements included in the failed chunk moving image file information list read in step S1403.

In step S1404, the control unit 201 checks for the cache state shown in column 904 of the failed chunk moving image file information. If it is determined that the cache state is set as absence (YES in step S1404), the control unit 201 advances the processing to step S1405. If it is determined that the cache state is set as presence (NO in step S1404), the control unit 201 checks for the next element of the failed chunk moving image file information list. Furthermore, in determination processing operations in step S1404 to step S1410, the control unit 201 checks for the next element included in the failed chunk moving image file information list, and, if there is no next element, the control unit 201 ends the flow of processing illustrated in FIG. 14.

In step S1405, the control unit 201 checks whether the image capturing apparatus 100 and the camera information shown in column 901 of the failed chunk moving image file information coincide with each other. If it is determined that the image capturing apparatus 100 and the camera information coincide with each other (YES in step S1405), the control unit 201 advances the processing to step S1406. If it is determined that the image capturing apparatus 100 and the camera information do not coincide with each other (NO in step S1405), the control unit 201 checks for the next element included in the failed chunk moving image file information list.

In step S1406, the control unit 201 checks whether the image file information acquired from the image capturing apparatus 100 in step S1401 coincides with the file name shown in column 902 of the failed chunk moving image file information and the image capturing date and time shown in column 903 thereof. If it is determined that the image file information coincides with the file name and the image capturing date and time (YES in step S1406), the control unit 201 advances the processing to step S1407. If it is determined that the image file information does not coincide with the file name and the image capturing date and time (NO in step S1406), the control unit 201 checks for the next element included in the failed chunk moving image file information list.

In step S1407, the control unit 201 receives a chunk moving image file from the image capturing apparatus 100 via the communication unit 211.

In step S1408, the control unit 201 determines whether the reception of the chunk moving image file transmitted from the image capturing apparatus 100 is successful. If it is determined that the reception of the chunk moving image file is successful (YES in step S1408), the control unit 201 advances the processing to step S1409. If it is determined that the reception of the chunk moving image file failed (NO in step S1408), the control unit 201 checks for the next element included in the failed chunk moving image file information list.

In step S1409, the control unit 201 stores the chunk moving image file in the cache region of the working memory 204.

In step S1410, with regard to the element of the failed chunk moving image file information corresponding to the chunk moving image file previously stored in the cache region of the working memory 204 in step S1409, the control unit 201 sets the cache state thereof as presence and thus updates the failed chunk moving image file information.

According to the above-described processing illustrated in FIG. 14, in a case where the cache state of the failed chunk moving image file information is set as absence, the communication apparatus 200 is able to automatically acquire a chunk moving image file from the image capturing apparatus 100 and appropriately update the cache state of the failed chunk moving image file information.

As described above, in the second embodiment, when having failed in receiving a chunk moving image file recorded by the image capturing apparatus 100, the communication apparatus 200 sets the cache state of the failed chunk moving image file information as absence and then stores the failed chunk moving image file information set as such in the working memory 204. Additionally, in a case where the cache state of the failed chunk moving image file information is set as absence, the communication apparatus 200 automatically acquires, at timing available for acquisition, a chunk moving image file the reception of which from the image capturing apparatus 100 failed and then stores the chunk moving image file in the cache region of the working memory 204.

Thus, even when having failed in receiving a chunk moving image file transmitted from the image capturing apparatus 100, the communication apparatus 200 automatically re-acquires the chunk moving image file from the image capturing apparatus 100. This enables the communication apparatus 200 to shorten a time required for re-acquiring a chunk moving image file.

In the second embodiment, when having acquired a moving image file generated by the image capturing apparatus 100 and having failed in transmitting the moving image file to the server 300, the communication apparatus 200 determines whether the moving image file the transmission of which to the server 300 failed is a chunk moving image file. Then, the communication apparatus 200 determines whether to delete data from the cache region of the working memory 204, but the second embodiment is not limited to this. For example, the communication apparatus 200 can determine whether a moving image file received from the image capturing apparatus 100 is a chunk moving image file and thus determine whether to delete data from the cache region of the working memory 204.

### Third Embodiment

Next, a third embodiment is described.

In the above-described second embodiment, with regard to the transfer app, when having failed in receiving a chunk moving image file transmitted from the image capturing apparatus 100, the communication apparatus 200 automatically acquires, at timing available for acquisition, the chunk moving image file the reception of which from the image capturing apparatus 100 failed.

In the third embodiment, a method in which, in a case where a chunk moving image file is present in the cache region of the working memory 204, the communication apparatus 200 automatically transmits the chunk moving image file to the server 300 is described.

Furthermore, in the third embodiment, the image capturing apparatus 100, the communication apparatus 200, the server 300, and the system configuration are similar to those in the first and second embodiments and are, therefore, omitted from description.

### List of Failed Chunk Moving Image File Information

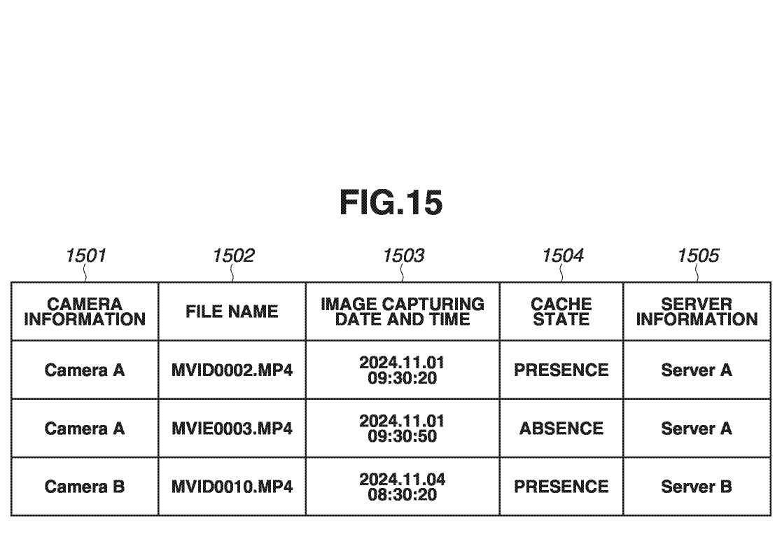

FIG. 15 is a diagram schematically showing a list of information indicating that the communication apparatus 200 has failed in receiving a chunk moving image file transmitted from the image capturing apparatus 100 or information indicating that the communication apparatus 200 has failed in transmitting a chunk moving image file to the server 300 in the third embodiment.

Furthermore, column 1501 to 1504 shown in FIG. 15 are similar to columns 901 to 904 shown in FIG. 9 and are, therefore, omitted from description.

Referring to FIG. 15, column 1505 represents server information about a transmission destination set when the communication apparatus 200 has failed in transmitting a chunk moving image file to the server 300. The server information indicates information required for transmission, such as the server name of an FTP server, a port number, a destination folder for a server, a user name, a password, and passive ON or OFF setting.

Preparing the above-mentioned list of failed chunk moving image file information enables appropriately managing information indicating whether the communication apparatus 200 has failed in receiving a chunk moving image file from the image capturing apparatus 100 or has failed in transmitting a chunk moving image file to the server 300 as well as the camera information about the camera serving as a receiving source and the transmission destination server information.

Furthermore, while, in the third embodiment, the server information required for transmission is assumed to be information concerning an FTP server, the third embodiment is not limited to this. For example, the server information required for transmission can be information concerning a server in File Transfer Protocol, such as a File Transfer Protocol Secure (FTPS) server, a Secure File Transfer Protocol (SFTP) server, or a Hypertext Transfer Protocol (HTTP) server.

### Processing Flow concerning Automatic Transmission of Chunk Moving Image File between Communication apparatus 200 and Server 300

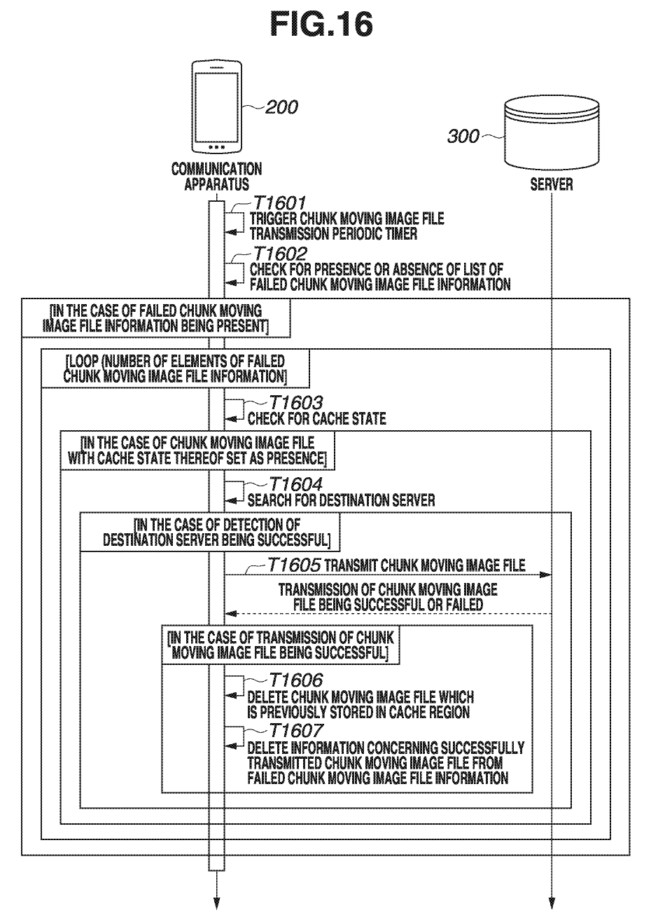

Next, processing for performing automatic transmission of a chunk moving image file to the server 300 via the communication unit 211 of the communication apparatus 200 in the third embodiment is described with reference to FIG. 16.

FIG. 16 is a diagram illustrating a processing sequence which is performed between the communication apparatus 200 and the server 300, in which the communication apparatus 200 automatically transmits a chunk moving image file the transmission of which failed to the server 300.

The processing illustrated in FIG. 16 is described as processing which is performed when the transfer app has been launched in the communication apparatus 200 and the communication apparatus 200 has triggered a chunk moving image file transmission periodic timer.

In step T1601, the communication apparatus 200 triggers the chunk moving image file transmission periodic timer.

In step T1602, the communication apparatus 200 checks for the presence or absence of a list of failed chunk moving image file information which is previously stored in the working memory 204. If the list of failed chunk moving image file information is present, then in step T1603 to step T1607, the communication apparatus 200 and the server 300 perform loop processing a number of times corresponding to the number of elements of the failed chunk moving image file information list.

In step T1603, the communication apparatus 200 checks for the cache state shown in column 1504 of the failed chunk moving image file information list which is previously stored in the working memory 204.

If the chunk moving image file concerned is a chunk moving image file with the cache state thereof set as presence, then in step T1604, the communication apparatus 200 searches for a destination server for transmission of the chunk moving image file. In the third embodiment, searching for a destination server refers to checking for the server information shown in column 1505 of the failed chunk moving image file information list and trying to detect a server to which the communication apparatus 200 is able to connect via the communication unit 211.

If the detection of a destination server is successful, then in step T1605, the communication apparatus 200 transmits a chunk moving image file to the detected server 300 via the communication unit 211, and then acquires, from the server 300, a status indicating whether the transmission of the chunk moving image file is successful or failed.

If the communication apparatus 200 has succeeded in transmitting the chunk moving image file to the server 300, then in step T1606, the communication apparatus 200 deletes the chunk moving image file which is previously stored in the cache region of the working memory 204.

In step T1607, if the transmission of the chunk moving image file to the server 300 is successful, the communication apparatus 200 deletes information concerning the chunk moving image file successfully transmitted to the server 300 from the list of failed chunk moving image file information.

### Processing Flow for Communication Apparatus 200 concerning Automatic Transmission of Chunk Moving Image File

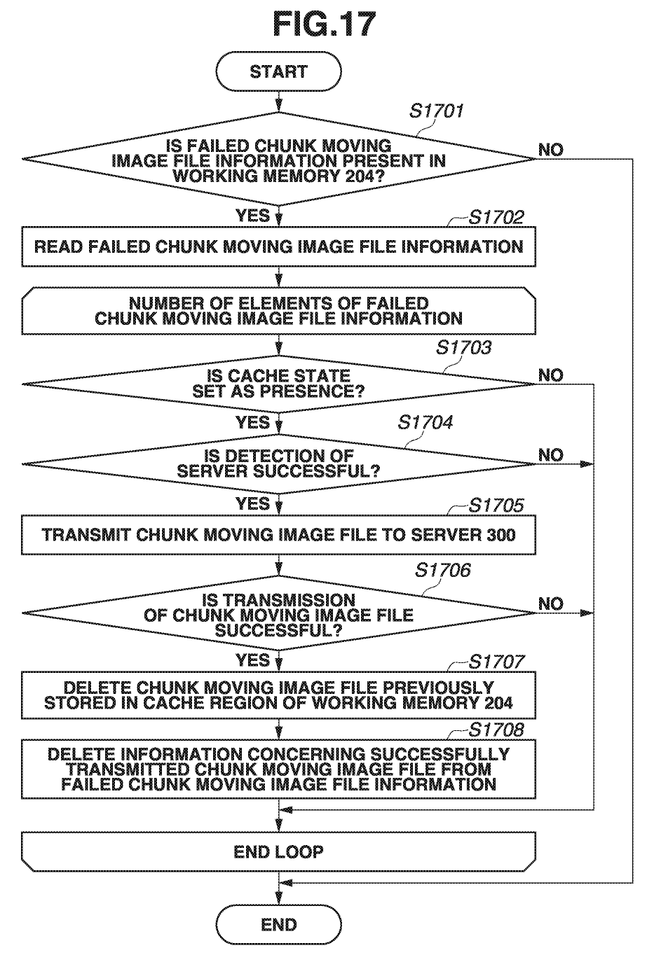

Next, a flow of processing for the communication apparatus 200 in which the communication apparatus 200 automatically transmits a chunk moving image file the transmission of which to the server 300 failed is described with reference to FIG. 17.

The processing illustrated in FIG. 17 is started at timing when the transfer app has been launched in the communication apparatus 200 and the control unit 201 of the communication apparatus 200 has triggered the chunk moving image file transmission periodic timer.

In step S1701, the control unit 201 of the communication apparatus 200 checks whether failed chunk moving image file information is present in the working memory 204 of the communication apparatus 200. If it is determined that failed chunk moving image file information is present (YES in step S1701), the control unit 201 advances the processing to step S1702. On the other hand, if it is determined that failed chunk moving image file information is not present (NO in step S1701), the control unit 201 ends the flow of processing illustrated in FIG. 17.

In step S1702, the control unit 201 reads the failed chunk moving image file information from the working memory 204.

In processing operations in step S1703 to step S1708, the control unit 201 performs loop processing a number of times corresponding to the number of elements included in the failed chunk moving image file information list read in step S1702.

In step S1703, the control unit 201 checks for the cache state shown in column 1504 of the failed chunk moving image file information. If the cache state is set as presence (YES in step S1703), the control unit 201 advances the processing to step S1704. If the cache state is set as absence (NO in step S1703), the control unit 201 checks for the next element of the failed chunk moving image file information list. Furthermore, in determination processing operations in step S1704 to step S1708, the control unit 201 checks for the next element of the failed chunk moving image file information list and, if there is no next element, the control unit 201 ends the flow of processing illustrated in FIG. 17.

In step S1704, the control unit 201 searches for a server available for transmission of a chunk moving image file and determines whether the detection of the server is successful. If it is determined that the detection of the server is successful (YES in step S1704), the control unit 201 advances the processing to step S1705. On the other hand, if it is determined that the detection of the server failed (NO in step S1704), the control unit 201 checks for the next element of the failed chunk moving image file information list.

In step S1705, the control unit 201 transmits, via the communication unit 211, the chunk moving image file to the server 300 detected in step S1704.

In step S1706, the control unit 201 determines whether the transmission of the chunk moving image file to the server 300 is successful. This determination is performed by receiving, from the server 300, a status indicating whether the transmission of the chunk moving image file failed.

If it is determined that the transmission of the chunk moving image file is successful (YES in step S1706), the control unit 201 advances the processing to step S1707. On the other hand, if it is determined that the transmission of the chunk moving image file failed (NO in step S1706), the control unit 201 checks for the next element of the failed chunk moving image file information list.

In step S1707, the control unit 201 deletes the chunk moving image file previously stored in the working memory 204.

In step S1708, the control unit 201 deletes information concerning the chunk moving image file transmitted to the server 300 from the list of failed chunk moving image file information.

According to the above-described processing illustrated in FIG. 17, in a case where the cache state of the failed chunk moving image file information is set as presence, the communication apparatus 200 tries to search for the server 300 from the server information included in the failed chunk moving image file information. Then, if the detection of the server 300 is successful, the communication apparatus 200 is able to automatically transmit a chunk moving image file to the server 300.

Furthermore, while, in the above description of the third embodiment, the retransmission of a chunk moving image file to the server 300 is performed at timing when the communication apparatus 200 has triggered the chunk moving image file transmission periodic timer, the third embodiment is not limited to this. For example, the retransmission of a chunk moving image file to the server 300 can be performed at timing when the communication apparatus 200 has connected to the image capturing apparatus 100 via the communication unit 211.

Moreover, the retransmission of a chunk moving image file to the server 300 can be performed at timing when the communication apparatus 200 has completed the reception of a chunk moving image file the reception of which from the image capturing apparatus 100 previously failed via the communication unit 211.

Moreover, in a case where the communication apparatus 200 has failed in transmitting a chunk moving image file due to the deterioration of the communication environment with the server 300, the retransmission of a chunk moving image file to the server 300 can be automatically performed when the communication environment with the server 300 is restored.

Moreover, in a case where the transmission of a chunk moving image file to the server 300 is successful, the communication apparatus 200 performs deletion of the chunk moving image file previously stored in the cache region of the working memory 204. Then, the communication apparatus 200 deletes transmitted chunk moving image file information from the failed chunk moving image file information, but the third embodiment is not limited to this. For example, the communication apparatus 200 can automatically delete a chunk moving image file and chunk moving image file information included in the failed chunk moving image file information, which are previously stored in the cache region of the working memory 204, after the elapse of a predetermined time.

As described above, in the third embodiment, at timing when the communication apparatus 200 has triggered the chunk moving image file transmission periodic timer, the communication apparatus 200 performs detection of the server 300 based on the server information included in the failed chunk moving image file information and thus periodically performs automatic transmission of chunk moving image files.

This enables saving the trouble of the user operating the communication apparatus 200 to select and transmit a chunk moving image file the transmission of which to the server 300 failed. Accordingly, it is possible to shorten a time required for retransmission of a chunk moving image file which the communication apparatus 200 has failed in transmitting to the server 300.

While, in the above-described embodiments, whether the moving image file concerned is a chunk recording file is determined with use of naming rules for files, the above-described embodiments are not limited to this.

For example, whether the moving image file concerned is a chunk recording file can be determined based on information included in a metadata information file of moving image data.

While some embodiments of the present disclosure have been described above, the present disclosure is not limited to these embodiments and can be modified or altered in various manners within the range of the gist thereof.

Furthermore, the present disclosure can also be implemented by performing the following processing. Thus, the processing includes supplying software (e.g., program) for implementing the functions of the above-described embodiments to a system or apparatus via a network or any type of storage medium and causing a computer (or, for example, a control unit or a micro processing unit (MPU)) of the system or apparatus to read out program code and execute the program code. In this case, each of the program and a storage medium storing the program constitutes the present disclosure.

While, in the above description, the present disclosure has been described in detail based on embodiments thereof, the present disclosure is not limited to such specific embodiments, and various aspects which do not depart from the gist of the present disclosure are also included in the present disclosure. Some or all of the above-described embodiments can be combined as appropriate.

Furthermore, each functional unit of the above-described embodiments (e.g., modifications) can be an individual piece of hardware or can be not so. The functions of two or more functional units can be implemented by shared hardware. Each of a plurality of functions of a single functional unit can be implemented by an individual piece of hardware. Two or more functions of one functional unit can be implemented by shared hardware. Moreover, each functional unit can be implemented by hardware such as an application specific integrated circuit (ASIC), a field-programmable gate array (FPGA), or a digital signal processor (DSP), or can be not so. For example, an apparatus can include a processor and a memory (e.g., storage medium) storing a control program. Then, the functions of at least some functional units included in the apparatus can be implemented by a processor reading out a control program from a memory and executing the control program.

The present disclosure can also be implemented by processing which supplies a program for implementing one or more functions of the above-described embodiments to a system or apparatus via a network or a storage medium and causes one or more processors included in a computer of the system or apparatus to read out the program and execute the program. Moreover, the present disclosure can also be implemented by a circuit which implements one or more functions of the above-described embodiments (for example, an ASIC).

### Configuration 1

A communication apparatus including:

a processor; and

a memory storing a program which, when executed by the processor, causes the communication apparatus to:

perform processing for acquiring data from a first apparatus;

perform processing for storing, in a storage unit, the data acquired from the first apparatus;

perform processing for transferring the data stored in the storage unit to a second apparatus different from the first apparatus; and

perform processing for, in a case where transfer of the data to the second apparatus failed, if the data the transfer of which failed is divided data constituting a data group, not deleting the divided data from the storage unit and, if the data the transfer of which failed is not divided data constituting the data group, deleting the data the transfer of which failed from the storge unit.

### Configuration 2

The communication apparatus as set forth in Configuration 1, wherein the program further causes the communication apparatus to perform processing for determining whether the data the transfer of which failed is divided data constituting the data group, based on a file name of the data acquired from the first apparatus.

### Configuration 3

The communication apparatus as set forth in Configuration 1 or 2, wherein the program further causes the communication apparatus to perform processing for, in a case where divided data constituting the data group is not stored in the storage unit, acquiring the divided data from the first apparatus.

### Configuration 4

The communication apparatus as set forth in any one of Configurations 1 to 3, wherein the program further causes the communication apparatus to perform processing for, in a case where transfer of divided data to the second apparatus failed, if the divided data is stored in the storage unit, retransferring the divided data to the second apparatus.

### Configuration 5

The communication apparatus as set forth in any one of Configurations 1 to 4, wherein the program further causes the communication apparatus to perform processing for acquiring notification information indicating that the divided data has been generated and acquiring the divided data based on the notification information.

### Configuration 6

The communication apparatus as set forth in Configuration 5, wherein the program further causes the communication apparatus to perform processing for storing, in the storage unit, information about divided data acquisition of which from the first apparatus failed and information about a first apparatus having transmitted the divided data while associating the respective pieces of information with each other.

### Configuration 7

The communication apparatus as set forth in Configuration 6, wherein the program further causes the communication apparatus to perform processing for, in a case where information about a first apparatus included in the notification information and information about a first apparatus associated with information about divided data acquisition of which from the first apparatus failed stored in the storage unit coincide with each other, acquiring divided data that is based on information about divided data associated with the first apparatus.

### Configuration 8

The communication apparatus as set forth in any one of Configurations 1 to 7, wherein the program further causes the communication apparatus to perform processing for, in a case where transfer of the divided data to the second apparatus failed, storing, in the storage unit, information about the divided data and information about the second apparatus while associating the respective pieces of information with each other.

### Configuration 9

The communication apparatus as set forth in Configuration 8, wherein the program further causes the communication apparatus to perform processing for, in a case where information about a second apparatus corresponding to information about divided data transfer of which to the second apparatus failed and information about a second apparatus with which the communication apparatus is communicating coincide with each other, transferring, to the second apparatus, divided data that is based on information about divided data associated with the second apparatus.

### Configuration 10

The communication apparatus as set forth in any one of Configurations 1 to 9,

wherein the first apparatus is an image capturing apparatus, and

wherein the data group is moving image data composed of a plurality of pieces of divided moving image data generated by the image capturing apparatus.

### Method

A control method, which is performed by a processor, for a communication apparatus, the control method including:

acquiring data from a first apparatus;

storing, in a storage unit, the data acquired from the first apparatus;

transferring the data stored in the storage unit to a second apparatus different from the first apparatus; and

in a case where transfer of the data to the second apparatus failed, if the data the transfer of which failed is divided data constituting a data group, not deleting the divided data from the storage unit and, if the data the transfer of which failed is not divided data constituting the data group, deleting the data the transfer of which failed from the storge unit.

### Storage Medium

A non-transitory computer-readable storage medium storing a program that, when executed by a computer, causes the computer to perform a control method for a communication apparatus, the control method including:

acquiring data from a first apparatus;

storing, in a storage unit, the data acquired from the first apparatus;

transferring the data stored in the storage unit to a second apparatus different from the first apparatus; and

in a case where transfer of the data to the second apparatus failed, if the data the transfer of which failed is divided data constituting a data group, not deleting the divided data from the storage unit and, if the data the transfer of which failed is not divided data constituting the data group, deleting the data the transfer of which failed from the storge unit.

According to an aspect of the present disclosure, it is possible to shorten a time required for retransmission of divided data the data transmission of which failed between apparatuses.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-019591 filed Feb. 7, 2025, which is hereby incorporated by reference herein in its entirety.

What is claimed is:

1. A communication apparatus comprising:
a processor; and
a memory storing a program which, when executed by the processor, causes the communication apparatus to:
perform processing for acquiring data from a first apparatus;
perform processing for storing, in a storage unit, the data acquired from the first apparatus;
perform processing for transferring the data stored in the storage unit to a second apparatus different from the first apparatus; and
perform processing for, in a case where transfer of the data to the second apparatus failed, if the data the transfer of which failed is divided data constituting a data group, not deleting the divided data from the storage unit and, if the data the transfer of which failed is not divided data constituting the data group, deleting the data the transfer of which failed from the storge unit.

2. The communication apparatus according to claim 1, wherein the program further causes the communication apparatus to perform processing for determining whether the data the transfer of which failed is divided data constituting the data group, based on a file name of the data acquired from the first apparatus.

3. The communication apparatus according to claim 1, wherein the program further causes the communication apparatus to perform processing for, in a case where divided data constituting the data group is not stored in the storage unit, acquiring the divided data from the first apparatus.

4. The communication apparatus according to claim 1, wherein the program further causes the communication apparatus to perform processing for, in a case where transfer of divided data to the second apparatus failed, if the divided data is stored in the storage unit, retransferring the divided data to the second apparatus.

5. The communication apparatus according to claim 1, wherein the program further causes the communication apparatus to perform processing for acquiring notification information indicating that the divided data has been generated and acquiring the divided data based on the notification information.

6. The communication apparatus according to claim 5, wherein the program further causes the communication apparatus to perform processing for storing, in the storage unit, information about divided data acquisition of which from the first apparatus failed and information about a first apparatus having transmitted the divided data while associating the respective pieces of information with each other.

7. The communication apparatus according to claim 6, wherein the program further causes the communication apparatus to perform processing for, in a case where information about a first apparatus included in the notification information and information about a first apparatus associated with information about divided data acquisition of which from the first apparatus failed stored in the storage unit coincide with each other, acquiring divided data that is based on information about divided data associated with the first apparatus.

8. The communication apparatus according to claim 1, wherein the program further causes the communication apparatus to perform processing for, in a case where transfer of the divided data to the second apparatus failed, storing, in the storage unit, information about the divided data and information about the second apparatus while associating the respective pieces of information with each other.

9. The communication apparatus according to claim 8, wherein the program further causes the communication apparatus to perform processing for, in a case where information about a second apparatus corresponding to information about divided data transfer of which to the second apparatus failed and information about a second apparatus with which the communication apparatus is communicating coincide with each other, transferring, to the second apparatus, divided data that is based on information about divided data associated with the second apparatus.

10. The communication apparatus according to claim 1,
wherein the first apparatus is an image capturing apparatus, and
wherein the data group is moving image data composed of a plurality of pieces of divided moving image data generated by the image capturing apparatus.

11. A control method, which is performed by a processor, for a communication apparatus, the control method comprising:
acquiring data from a first apparatus;
storing, in a storage unit, the data acquired from the first apparatus;
transferring the data stored in the storage unit to a second apparatus different from the first apparatus; and
in a case where transfer of the data to the second apparatus failed, if the data the transfer of which failed is divided data constituting a data group, not deleting the divided data from the storage unit and, if the data the transfer of which failed is not divided data constituting the data group, deleting the data the transfer of which failed from the storge unit.

12. A non-transitory computer-readable storage medium storing a program that, when executed by a computer, causes the computer to perform a control method for a communication apparatus, the control method comprising:
acquiring data from a first apparatus;
storing, in a storage unit, the data acquired from the first apparatus;
transferring the data stored in the storage unit to a second apparatus different from the first apparatus; and
in a case where transfer of the data to the second apparatus failed, if the data the transfer of which failed is divided data constituting a data group, not deleting the divided data from the storage unit and, if the data the transfer of which failed is not divided data constituting the data group, deleting the data the transfer of which failed from the storge unit.
